(19) United States
(12) Patent Application Publication
(10) Pub. No.: US 2026/0067085 A1
(43) Pub. Date: Mar. 5, 2026

(54) AUTHORIZATION REVOCATION METHODS

(71) Applicant: BEIJING XIAOMI MOBILE SOFTWARE CO., LTD., Beijing (CN)

(72) Inventors: Haoran LIANG, Beijing (CN); Wei LU, Beijing (CN)

(73) Assignee: BEIJING XIAOMI MOBILE SOFTWARE CO., LTD., Beijing (CN)

(21) Appl. No.: 19/114,654

(22) PCT Filed: Sep. 29, 2022
(86) PCT No.: PCT/CN2022/122959

§ 371 Date: Mar. 24, 2025

(51) Int. Cl. H04L 9/32; G06F 9/54

(52) U.S. Cl. CPC H04L 9/3213; G06F 9/547; H04L 9/3273

(57) ABSTRACT

An authorization revocation method and apparatus. The method comprises: receiving a first authorization revocation request sent by an API invoking entity, verifying the first authorization revocation request; and if the verification is passed, revoking a token corresponding to the first authorization revocation request. A processing method is provided for the situation of “authorization revocation”, so that a CAPIF core function or authorization function revokes, according to an authorization revocation request sent by the API invoking entity, a related token used when accessing a resource of a UE, and thus potential threats caused by token leakage can be reduced.

### CROSS-REFERENCE TO RELATED APPLICATIONS

This application is a U.S. National Phase Application of International Application No. PCT/CN2022/122959, filed on Sep. 29, 2022, the content of which is hereby incorporated by reference in its entirety.

### TECHNICAL FIELD

The disclosure relates to the field of communication technology, and in particular to a method and an apparatus for authorization revocation, a device and a storage medium.

### BACKGROUND

One of the objectives of the study on application (APP) security is about obtaining authorization from a resource owner (i.e., user equipment (UE)). The common application programming interface framework (CAPIF) core function/authorization function can authorize an application programming interface (API) invoker if the UE grants the API invoker to request its resources. With related tokens, the API invoker can access the resources of UE via an API exposure function. However, the API invoker and the CAPIF core function/authorization function cannot actively revoke the related tokens, and there is a potential threat of token disclosure.

### SUMMARY

According to a first aspect of the disclosure, a method for authorization revocation is provided. The method is performed by a CAPIF core function/authorization function, including: receiving a first authorization revocation request sent by an API invoker; verifying the first authorization revocation request; and in response to verification of the first authorization revocation request being passed, revoking a token corresponding to the first authorization revocation request.

According to a second aspect of the disclosure, a method for authorization revocation is provided. The method is performed by an API invoker, including: sending a first authorization revocation request to a CAPIF core function/authorization function.

According to a third aspect of the disclosure, a method for authorization revocation is provided. The method is performed by an API exposure function, including: receiving a second authorization revocation request sent by a CAPIF core function/authorization function, in which the second authorization revocation request indicates the API exposure function to revoke a second token that needs to be revoked; and setting the second token that needs to be revoked as invalid.

### BRIEF DESCRIPTION OF THE DRAWINGS

The above-mentioned and/or additional aspects and advantages of the disclosure will become apparent and readily appreciated from the following description of embodiments, taken in combination with the accompanying drawings.

FIG. 1 is a flow chart illustrating a method for authorization revocation provided in an embodiment of the disclosure.

FIG. 2 is a schematic diagram illustrating an interaction of a method for authorization revocation provided in an embodiment of the disclosure.

FIG. 3 is a flow chart illustrating a method for authorization revocation provided in another embodiment of the disclosure.

FIG. 4 is a schematic diagram illustrating an interaction of a method for authorization revocation provided in another embodiment of the disclosure.

FIG. 5 is a flow chart illustrating a method for authorization revocation provided in another embodiment of the disclosure.

FIG. 6 is a flow chart illustrating a method for authorization revocation provided in another embodiment of the disclosure.

FIG. 7 is a flow chart illustrating a method for authorization revocation provided in another embodiment of the disclosure.

FIG. 8 is a schematic diagram illustrating an interaction of a method for authorization revocation provided in another embodiment of the disclosure.

FIG. 9 is a flow chart illustrating a method for authorization revocation provided in another embodiment of the disclosure.

FIG. 10 is a flow chart illustrating a method for authorization revocation provided in another embodiment of the disclosure.

FIG. 11 is a flow chart illustrating a method for authorization revocation provided in another embodiment of the disclosure.

FIG. 12 is a schematic diagram illustrating an interaction of a method for authorization revocation provided in another embodiment of the disclosure.

FIG. 13 is a flow chart illustrating a method for authorization revocation provided in another embodiment of the disclosure.

FIG. 14 is a flow chart illustrating a method for authorization revocation provided in another embodiment of the disclosure.

FIG. 15 is a flow chart illustrating a method for authorization revocation provided in another embodiment of the disclosure.

FIG. 16 is a flow chart illustrating a method for authorization revocation provided in another embodiment of the disclosure.

FIG. 17 is a flow chart illustrating a method for authorization revocation provided in another embodiment of the disclosure.

FIG. 18 is a schematic diagram illustrating an interaction of a method for authorization revocation provided in another embodiment of the disclosure.

FIG. 19 is a flow chart illustrating a method for authorization revocation provided in another embodiment of the disclosure.

FIG. 20 is a schematic diagram illustrating an interaction of a method for authorization revocation provided in another embodiment of the disclosure.

FIG. 21 is a flow chart illustrating a method for authorization revocation provided in another embodiment of the disclosure.

FIG. 22 is a flow chart illustrating a method for authorization revocation provided in another embodiment of the disclosure.

FIG. 23 is a flow chart illustrating a method for authorization revocation provided in another embodiment of the disclosure.

FIG. 24 is a flow chart illustrating a method for authorization revocation provided in another embodiment of the disclosure.

FIG. 25 is a flow chart illustrating a method for authorization revocation provided in another embodiment of the disclosure.

FIG. 26 is a schematic diagram illustrating an interaction of a method for authorization revocation provided in another embodiment of the disclosure.

FIG. 27 is a flow chart illustrating a method for authorization revocation provided in another embodiment of the disclosure.

FIG. 28 is a schematic diagram illustrating an interaction of a method for authorization revocation provided in another embodiment of the disclosure.

FIG. 29 is a flow chart illustrating a method for authorization revocation provided in another embodiment of the disclosure.

FIG. 30 is a flow chart illustrating a method for authorization revocation provided in another embodiment of the disclosure.

FIG. 31 is a flow chart illustrating a method for authorization revocation provided in another embodiment of the disclosure.

FIG. 32 is a schematic diagram illustrating an interaction of a method for authorization revocation provided in another embodiment of the disclosure.

FIG. 33 is a schematic diagram illustrating an interaction of a method for authorization revocation provided in another embodiment of the disclosure.

FIG. 34 is a structural block diagram illustrating an apparatus for authorization revocation provided in an embodiment of the disclosure.

FIG. 35 is a structural block diagram illustrating an apparatus for authorization revocation provided in another embodiment of the disclosure.

FIG. 36 is a structural block diagram illustrating an apparatus for authorization revocation provided in another embodiment of the disclosure.

FIG. 37 is a structural block diagram illustrating an apparatus for authorization revocation provided in another embodiment of the disclosure.

FIG. 38 is a structural block diagram illustrating an apparatus for authorization revocation provided in another embodiment of the disclosure.

FIG. 39 is a structural block diagram illustrating an apparatus for authorization revocation provided in another embodiment of the disclosure.

FIG. 40 is a block diagram illustrating a user equipment (UE) for authorization revocation provided in an embodiment of the disclosure.

FIG. 41 is a block diagram illustrating a network device for authorization revocation provided in another embodiment of the disclosure.

### DETAILED DESCRIPTION

Reference will now be made in detail to the exemplary embodiments, examples of which are illustrated in the accompanying drawings. When the following description refers to the accompanying drawings, the same numerals in different drawings refer to the same or similar elements unless otherwise indicated. The implementations described in the following exemplary embodiments do not represent all implementations consistent with the embodiments of the disclosure. Rather, they are merely examples of devices and methods consistent with some aspects of the embodiments of the disclosure as recited in the appended claims.

Terms used in the embodiments of the disclosure are for the purpose of describing specific embodiments only, and are not intended to limit the embodiments of the disclosure. As used in the examples of this disclosure and the appended claims, the singular forms “a/an”, “said” and “the” are also intended to include the plural forms unless the context clearly dictates otherwise. It should also be understood that the term “and/or” as used herein refers to and includes any and all possible combinations of one or more of the associated listed items.

It may be understood that although the terms first, second, third, etc. may be used to describe various information in the embodiments of the present disclosure, such information should not be limited to these terms. These terms are used only to distinguish information in the same type from one another. For example, without departing from the scope of embodiments of the present disclosure, the first information may also be referred to as the second information, and similarly, the second information may be referred to as the first information. Depending on the context, words “if” and “in the case that” used here may be interpreted as “when”, “while”, or “in response to determining.”.

Network elements or network functions involved in embodiments of the disclosure may be implemented by a separate hardware device or by software in the hardware device. This is not limited in the embodiments of the disclosure.

One of the objectives of the study on application (APP) security, for example, school notification & attendance (SNA) APP security, is about obtaining authorization from the resource owner (i.e., user equipment (UE)). In relevant communication standards, it is stated that “allow the UE to provide/revoke consent for information (e.g., location, presence) to be shared with the third-party”.

That is, a common application programming interface framework (CAPIF) core function/authorization function can authorize an application programming interface (API) invoker via open authorization (OAuth) 2.0 if the UE grants the API invoker to request its resources (e.g., location information). Then, with the related tokens (e.g., refresh token/access token), the API invoker can access the resources of UE via the API exposure function.

However, the API invoker and the CAPIF core function/authorization function cannot actively revoke the related tokens, and there is a potential threat of token disclosure.

In an embodiment of the disclosure, the resource owner may be a UE. The UE may be devices that provide voice and/or data connectivity to the user. The UE may communicate with one or more core networks via a Radio Access Network (RAN). The UE may be Internet of Things (IoT) terminal, such as sensor devices, mobile telephones (also known as a “cellular” phone), or computers with the IoT terminal, which for example, may be stationary, portable, pocket-size, hand-held, computer-built, or vehicle-mounted device. The UE is, for example, a Station (STA), a subscriber unit, a subscriber station, a mobile station, a mobile, a remote station, a access point, a remote terminal, a access terminal, a user terminal, a user agent or a user equipment. Alternatively, the UE may also be an unmanned aerial vehicle (UAV) device. Alternatively, the UE may be an in-vehicle device, which for example, may be a traveling computer with wireless communication capabilities, or a wireless terminal that is externally connected to an Electronic Control Unit (ECU). Alternatively, the UE may be a roadside device, e.g., may be a street light, a signal light, or other roadside device, etc., with wireless communication capabilities.

A method and an apparatus for authorization revocation, a device and a storage medium provided in embodiments of the disclosure are described in detail below with reference to the accompanying drawings.

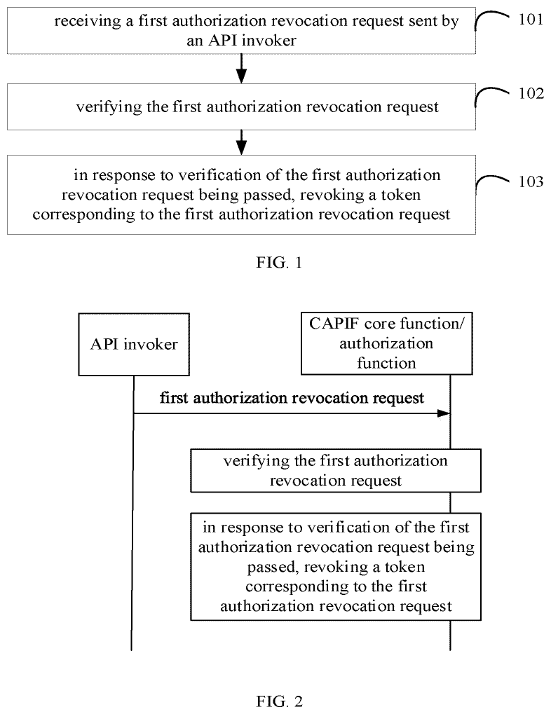

FIG. 1 is a flow chart illustrating a method for authorization revocation provided in an embodiment of the disclosure. The method is performed by a CAPIF core function/authorization function. As shown in FIG. 1, the method may include the following steps 101 to 103.
At step 101, a first authorization revocation request sent by an API invoker is received.
At step 102, the first authorization revocation request is verified.
At step 103, in response to verification of the first authorization revocation request being passed, a token corresponding to the first authorization revocation request is revoked.

In an embodiment of the disclosure, the API invoker may be a UE or an application function (AF) in SNA scenarios. The API invoker may obtain API invocation authorization information from the UE or the CAPFI core function/authorization function. With the API exposure function, the API invoker can trigger a specific API to obtain or update a specific resource of the UE.

Optionally, in an embodiment of the disclosure, the specific resource includes at least one of: location information of the UE; or quality of service (QOS) information of the UE.

Optionally, in an embodiment of the disclosure, the API invocation authorization information includes at least one of: an access token; or a refresh token.

In an embodiment of the disclosure, the API invoker may trigger authorization revocation, i.e., send the first authorization revocation request to the CAPIF core function/authorization function, when the token, e.g., the access token or refresh token, is under the potential threats of disclosure.

In an embodiment of the disclosure, the API invoker may also send the first authorization revocation request to the CAPIF core function/authorization function when the UE disconnects from the API invoker or requests the authorization revocation.

For example, in an embodiment of the disclosure, the token corresponding to the first authorization revocation request includes at least one of the following information: a token type, such as an access token, a refresh token, and etc.; a CAPIF core function identity; a CAPIF authorization function identity; an API invoker identity; a UE identity; an API exposure function identity; a service API identifier; a service identifier; a service operation identifier; a target resource identifier; a geographic area; or an expired time.

For example, in an embodiment of the disclosure, the first authorization revocation request includes authorization information that needs to be revoked.

In an embodiment of the disclosure, the first authorization revocation request includes at least one of: an API invoker identity; a first token that needs to be revoked; or a token type corresponding to the first token that needs to be revoked.

For example, in an embodiment of the disclosure, when the CAPIF core function/authorization function revokes the token corresponding to the first authorization revocation request, the token corresponding to the first authorization revocation request will be invalid.

In an embodiment of the disclosure, FIG. 2 is a schematic diagram illustrating an interaction of a method for authorization revocation provided in an embodiment of the disclosure. As shown in FIG. 2, the API invoker may send the first authorization revocation request to the CAPIF core function/authorization function. When the CAPIF core function/authorization function receives the first authorization revocation request, the CAPIF core function/authorization function may verify the first authorization revocation request. If the CAPIF core function/authorization function determines that verification of the first authorization revocation request is passed, the CAPIF core function/authorization function may revoke the token corresponding to the first authorization revocation request.

In summary, in embodiments of the disclosure, the first authorization revocation request sent by the API invoker is received; the first authorization revocation request is verified; and in response to verification of the first authorization revocation request being passed, the token corresponding to the first authorization revocation request is revoked. In embodiments of the disclosure, the CAPIF core function/authorization function revokes the related token used for accessing resources of the UE based on the authorization revocation request sent by the API invoker, which may enable the CAPIF core function/authorization function to actively revoke the related token used for accessing resources of the UE, and may thus reduce potential threats due to the token disclosure.

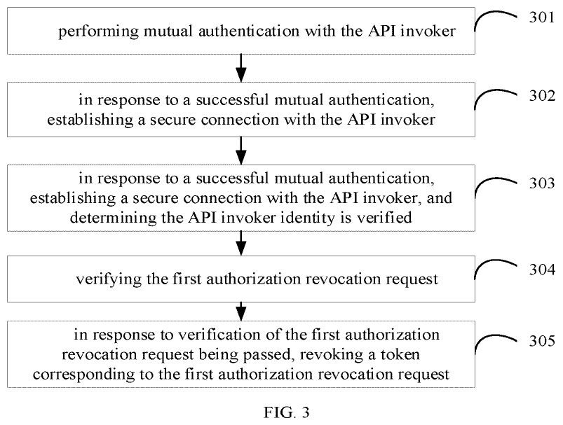

FIG. 3 is a flow chart illustrating a method for authorization revocation provided in an embodiment o the disclosure. The method is performed by a CAPIF core function/authorization function. As shown in FIG. 3, the method may include the following steps 301 to 305.
At step 301, mutual authentication is performed with the API invoker.
At step 302, in response to a successful mutual authentication, a secure connection with the API invoker is established, and it is determined the API invoker identity is verified.
At step 303, a first authorization revocation request sent by an API invoker is received.
At step 304, the first authorization revocation request is verified.
At step 305, in response to verification of the first authorization revocation request being passed, a token corresponding to the first authorization revocation request is revoked.

For example, in an embodiment of the disclosure, the first authorization revocation request includes at least one of: an API invoker identity; a first token that needs to be revoked; or a token type corresponding to the first token that needs to be revoked.

Optionally, in an embodiment of the disclosure, the CAPIF core function/authorization function and the API invoker can do mutual authentication by using at least one of the following authentication mechanisms:
a mutual authentication based on transport layer security pre-shared key ciphersuites (TLS-PSK), public key infrastructure (PKI), and OAuth token,
a generic bootstrapping architecture (GBA)-based authentication mechanism,
an authentication and key management for applications (AKMA)-based authentication mechanism, or
certificate-based authentication mechanism.

Optionally, in an embodiment of the disclosure, when the CAPIF core function/authorization function establishes a secure connection with the API invoker in response to the successful mutual authentication, the secure connection may be established via TLS.

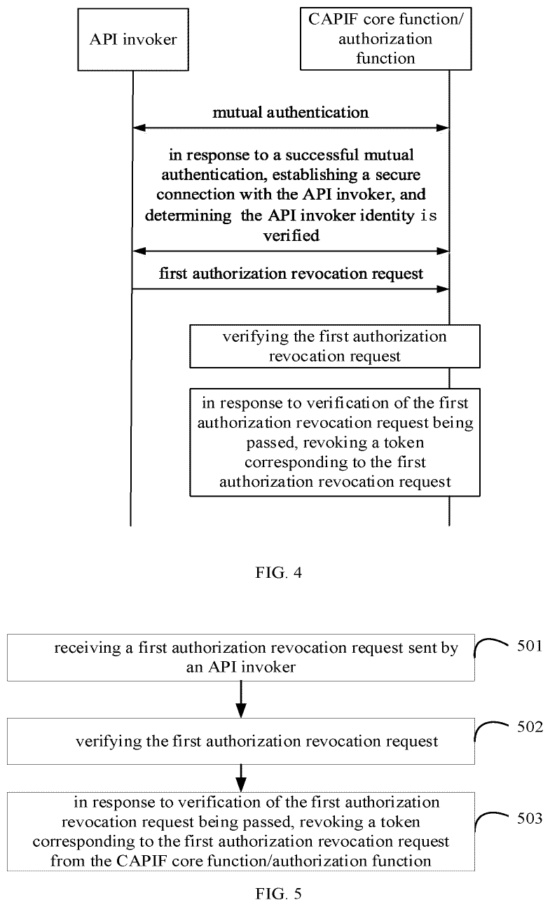

In an embodiment of the disclosure, FIG. 4 is a schematic diagram illustrating an interaction of a method for authorization revocation provided in an embodiment of the disclosure. As shown in FIG. 4, the CAPIF core function/authorization function may perform mutual authentication with the API invoker, and in response to the successful mutual authentication, the CAPIF core function/authorization function may establish the secure connection with the API invoker, and determine the API invoker identity is verified. The API invoker may send the first authorization revocation request to the CAPIF core function/authorization function. When the CAPIF core function/authorization function receives the first authorization revocation request, the CAPIF core function/authorization function may verify the first authorization revocation request. If the CAPIF core function/authorization function determines that the first authorization revocation request passes the verification, the CAPIF core function/authorization function may revoke the token corresponding to the first authorization revocation request.

In summary, in embodiments of the disclosure, the mutual authentication is performed with the API invoker; in response to the successful mutual authentication, the secure connection with the API invoker is established, and it is determined the API invoker identity is verified; the first authorization revocation request sent by the API invoker is received; the first authorization revocation request is verified; and in response to verification of the first authorization revocation request being passed, the token corresponding to the first authorization revocation request is revoked. In embodiments of the disclosure, the CAPIF core function/authorization function revokes the related token used for accessing resources of the UE based on the authorization revocation request sent by the API invoker, which may enable the CAPIF core function/authorization function to actively revoke the related token used for accessing resources of the UE, and thus reduce potential threats due to the token disclosure.

FIG. 5 is a flow chart illustrating a method for authorization revocation provided in an embodiment of the disclosure. The method is performed by a CAPIF core function/authorization function. As shown in FIG. 5, the method may include the following steps 501 to 503.
At step 501, a first authorization revocation request sent by an API invoker is received.
At step 502, the first authorization revocation request is verified.
At step 503, in response to verification of the first authorization revocation request being passed, a token corresponding to the first authorization revocation request is revoked.

For example, in an embodiment of the disclosure, the first authorization revocation request includes at least one of: an API invoker identity; a first token that needs to be revoked; or a token type corresponding to the first token that needs to be revoked.

In summary, in embodiments of the disclosure, the first authorization revocation request sent by the API invoker is received; the first authorization revocation request is verified; and in response to verification of the first authorization revocation request being passed, the token corresponding to the first authorization revocation request is revoked. In embodiments of the disclosure, the CAPIF core function/authorization function revokes the related token used for accessing resources of the UE based on the authorization revocation request sent by the API invoker, which may enable the CAPIF core function/authorization function to actively revoke the related token used for accessing resources of the UE, and thus reduce potential threats due to the token disclosure.

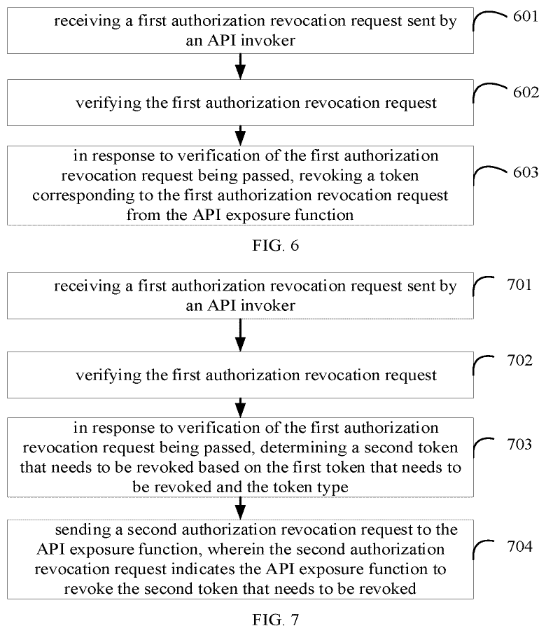

FIG. 6 is a flow chart illustrating a method for authorization revocation provided in an embodiment of the disclosure. The method is performed by a CAPIF core function/authorization function. As shown in FIG. 6, the method may include the following steps 601 to 603.
At step 601, a first authorization revocation request sent by an API invoker is received.
At step 602, the first authorization revocation request is verified.
At step 603, in response to verification of the first authorization revocation request being passed, a token corresponding to the first authorization revocation request is revoked from an API exposure function.

For example, in an embodiment of the disclosure, the first authorization revocation request includes at least one of: an API invoker identity; a first token that needs to be revoked; or a token type corresponding to the first token that needs to be revoked.

In summary, in embodiments of the disclosure, the first authorization revocation request sent by the API invoker is received; the first authorization revocation request is verified; and in response to verification of the first authorization revocation request being passed, the token corresponding to the first authorization revocation request is revoked from the API exposure function. In embodiments of the disclosure, the CAPIF core function/authorization function revokes the related token used for accessing resources of the UE based on the authorization revocation request sent by the API invoker, which may enable the CAPIF core function/authorization function to actively revoke the related token used for accessing resources of the UE, and thus reduce potential threats due to the token disclosure.

FIG. 7 is a flow chart illustrating a method for authorization revocation provided in an embodiment of the disclosure. The method is performed by a CAPIF core function/authorization function. As shown in FIG. 7, the method may include the following steps 701 to 704.
At step 701, a first authorization revocation request sent by an API invoker is received.
At step 702, the first authorization revocation request is verified.
At step 703, in response to verification of the first authorization revocation request being passed, a second token that needs to be revoked is determined based on the first token that needs to be revoked and the token type.

At step 704, a second authorization revocation request is sent to the API exposure function, in which the second authorization revocation request indicates the API exposure function to revoke the second token that needs to be revoked.

For example, in an embodiment of the disclosure, the first authorization revocation request includes at least one of: an API invoker identity; a first token that needs to be revoked; or a token type corresponding to the first token that needs to be revoked.

In an embodiment of the disclosure, when the API exposure function revokes the second authorization revocation request based on the second authorization revocation request, the API exposure function may send the first authorization revocation response to the CAPIF core function/authorization function, i.e., the CAPIF core function/authorization function may receive the first authorization revocation response fed back by the API exposure function.

In an embodiment of the disclosure, if the first token that needs to be revoked is an access token, the first token that needs to be revoked is used as the second token that needs to be revoked.

If the first token that needs to be revoked is a refresh token, the access token corresponding to the first token that needs to be revoked is used as the second token that needs to be revoked.

For example, in an embodiment of the disclosure, when the CAPIF core function/authorization function sends the second authorization revocation request to the API exposure function, the CAPIF core function/authorization function may send the second token that needs to be revoked to the API exposure function, for the API exposure function to revoke the second token that needs to be revoked based on the second authorization revocation request.

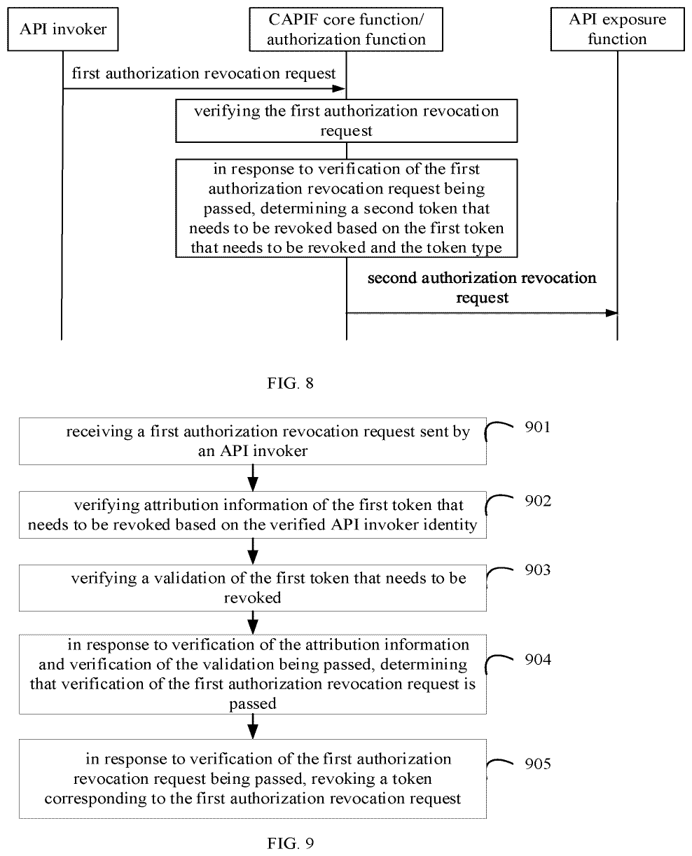

In an embodiment of the disclosure, FIG. 8 is a schematic diagram illustrating an interaction of a method for authorization revocation provided in an embodiment of the disclosure. As shown in FIG. 8, the API invoker may send the first authorization revocation request to the CAPIF core function/authorization function. When the CAPIF core function/authorization function receives the first authorization revocation request, the CAPIF core function/authorization function may verify the first authorization revocation request. If the CAPIF core function/authorization function determines that verification of the first authorization revocation request is passed, the CAPIF core function/authorization function may determine the second token that needs to be revoked based on the first token that needs to be revoked and the token type. Then, the CAPIF core function/authorization function may send the second authorization revocation request to the API exposure function.

In summary, in embodiments of the disclosure, the first authorization revocation request sent by the API invoker is received; the first authorization revocation request is verified; and in response to verification of the first authorization revocation request being passed, the second token that needs to be revoked is determined based on the first token that needs to be revoked and the token type; and the second authorization revocation request is sent to the API exposure function. In embodiments of the disclosure, the CAPIF core function/authorization function revokes the related token used for accessing resources of the UE based on the authorization revocation request sent by the API invoker, which may enable the CAPIF core function/authorization function to actively revoke the related token used for accessing resources of the UE, and thus reduce potential threats due to the token disclosure.

FIG. 9 is a flow chart illustrating a method for authorization revocation provided in an embodiment of the disclosure. The method is performed by a CAPIF core function/authorization function. As shown in FIG. 9, the method may include the following steps 901 to 905.
At step 901, a first authorization revocation request sent by an API invoker is received.
At step 902, attribution information of the first token that needs to be revoked is verified based on the verified API invoker identity.
At step 903, a validation of the first token that needs to be revoked is verified.
At step 904, in response to verification of the attribution information and verification of the validation being passed, it is determined that verification of the first authorization passed.
At step 905, in response to verification of the first authorization revocation request being passed, a token corresponding to the first authorization revocation request is revoked.

For example, in an embodiment of the disclosure, the first authorization revocation request includes an API invoker identity and the first token that needs to be revoked.

In an embodiment of the disclosure, the first authorization revocation request may further include a token type corresponding to the first token that needs to be revoked.

Optionally, in an embodiment of the disclosure, when the CAPIF core function/authorization function verifies the attribution information of the first token that needs to be revoked based on the verified API invoker identity, the CAPIF core function/authorization function may verify the attribution information of the first token that needs to be revoked by: determining whether the verified API invoker identity is identical to the API invoker identity corresponding to the first token that needs to be revoked, or determining whether the verified API invoker identity may be mapped to the API invoker identity corresponding to the first token that needs to be revoked.

In an embodiment of the disclosure, if the verified API invoker identity is identical to the API invoker identity corresponding to the first token that needs to be revoked, or if the verified API invoker identity may be mapped to the API invoker identity corresponding to the first token that needs to be revoked, the verification of the attribution information of the first token that needs to be revoked is passed.

Optionally, in an embodiment of the disclosure, the CAPIF core function/authorization function may perform mutual authentication with the API invoker. In response to a successful mutual authentication, the CAPIF core function/authorization function may establish a secure connection with the API invoker, and determine the API invoker identity is verified.

Optionally, in an embodiment of the disclosure, when the CAPIF core function/authorization function verifies a validation of the first token that needs to be revoked, the CAPIF core function/authorization function may leverage a public key or a local policy to verify the validation of the first token that needs to be revoked. If the verification result indicates that the first token that needs to be revoked is not modified, the first token that needs to be revoked is valid. If the verification result indicates that the first token that needs to be revoked is modified, the first token that needs to be revoked is invalid.

In summary, in an embodiment of the disclosure, the first authorization revocation request sent by the API invoker is received; the attribution information of the first token that needs to be revoked is verified based on the verified API invoker identity; the validation of the first token that needs to be revoked is verified; in response to verification of the attribution information and verification of the validation being passed, it is determined that the verification of the first authorization revocation request is passed; in response to verification of the first authorization revocation request being passed, a token corresponding to the first authorization revocation request is revoked. In embodiments of the disclosure, the CAPIF core function/authorization function revokes the related token used for accessing resources of the UE based on the authorization revocation request sent by the API invoker, which may enable the CAPIF core function/authorization function to actively revoke the related token used for accessing resources of the UE, and thus reduce potential threats due to the token disclosure.

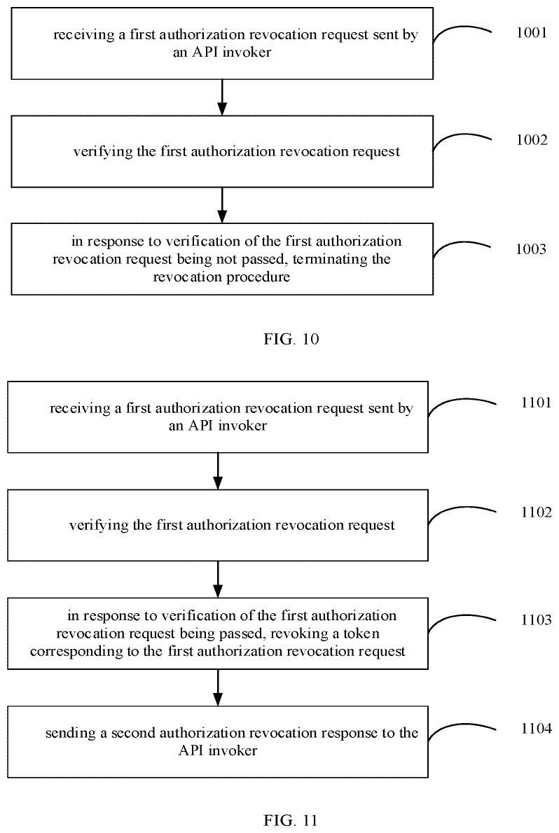

FIG. 10 is a flow chart illustrating a method for authorization revocation provided in an embodiment of the disclosure. The method is performed by a CAPIF core function/authorization function. As shown in FIG. 10, the method may include the following steps 1001 to 1003.
At step 1001, a first authorization revocation request sent by an API invoker is received.
At step 1002, the first authorization revocation request is verified.
At step 1003, in response to verification of the first authorization revocation request being not passed, the revocation procedure is terminated.

For example, in an embodiment of the disclosure, the first authorization revocation request includes at least one of: an API invoker identity; a first token that needs to be revoked; or a token type corresponding to the first token that needs to be revoked.

In summary, in embodiments of the disclosure, the first authorization revocation request sent by the API invoker is received; the first authorization revocation request is verified; and in response to verification of the first authorization revocation request being not passed, the revocation procedure is terminated. In embodiments of the disclosure, the CAPIF core function/authorization function revokes the related token used for accessing resources of the UE based on the authorization revocation request sent by the API invoker, which may enable the CAPIF core function/authorization function to actively revoke the related token used for accessing resources of the UE, and thus reduce potential threats due to the token disclosure.

FIG. 11 is a flow chart illustrating a method for authorization revocation provided in an embodiment of the disclosure. The method is performed by a CAPIF core function/authorization function. As shown in FIG. 11, the method may include the following steps 1101 to 1104.
At step 1101, a first authorization revocation request sent by an API invoker is received.
At step 1102, the first authorization revocation request is verified.
At step 1103, in response to verification of the first authorization revocation request being passed, a token corresponding to the first authorization revocation request is revoked.
At step 1104, a second authorization revocation response is sent to the API invoker.

For example, in an embodiment of the disclosure, the first authorization revocation request includes at least one of: an API invoker identity; a first token that needs to be revoked; or a token type corresponding to the first token that needs to be revoked.

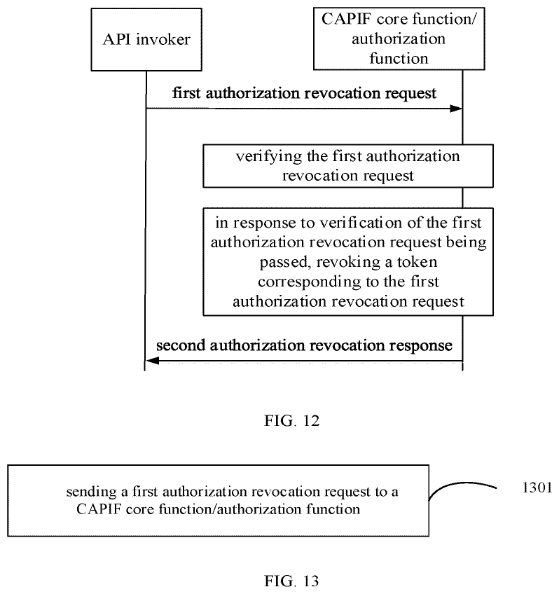

In an embodiment of the disclosure, FIG. 12 is a schematic diagram illustrating an interaction of a method for authorization revocation provided in an embodiment of the disclosure. As shown in FIG. 12, the API invoker may send a first authorization revocation request to the CAPIF core function/authorization function. When the CAPIF core function/authorization function receives the first authorization revocation request, the CAPIF core function/authorization function may verify the first authorization revocation request. If the CAPIF core function/authorization function determines that verification of the first authorization revocation request is passed, the CAPIF core function/authorization function may revoke the token corresponding to the first authorization revocation request. When the CAPIF core function/authorization function revokes the token corresponding to the first authorization revocation request, the CAPIF core function/authorization function may send a second authorization revocation response to the API invoker.

In summary, in embodiments of the disclosure, the first authorization revocation request sent by the API invoker is received; the first authorization revocation request is verified; in response to verification of the first authorization revocation request being passed, the token corresponding to the first authorization revocation request is revoked; and the second authorization revocation response is sent to the API invoker. In embodiments of the disclosure, the CAPIF core function/authorization function revokes the related token used for accessing resources of the UE based on the authorization revocation request sent by the API invoker, which may enable the CAPIF core function/authorization function to actively revoke the related token used for accessing resources of the UE, and thus reduce potential threats due to the token disclosure.

FIG. 13 is a flow chart illustrating a method for authorization revocation provided in an embodiment of the disclosure. The method is performed by an API invoker. As shown in FIG. 13, the method may include the following step 1301.

At step 1301, a first authorization revocation request is sent to a CAPIF core function/authorization function.

In an embodiment of the disclosure, the API invoker may be a UE or an AF in SNA scenarios. The API invoker may obtain API invocation authorization information from the UE or the CAPFI core function/authorization function. With the API exposure function, the API invoker can trigger a specific API to obtain or update a specific resource of the UE.

Optionally, in an embodiment of the disclosure, the specific resource includes at least one of: location information of the UE; or QoS information of the UE.

Optionally, in an embodiment of the disclosure, the API invocation authorization information includes at least one of: an access token; or a refresh token.

For example, in an embodiment of the disclosure, the first authorization revocation request includes authorization information that needs to be revoked.

For example, in an embodiment of the disclosure, the first authorization revocation request includes at least one of: an API invoker identity; a first token that needs to be revoked; or a token type corresponding to the first token that needs to be revoked.

In summary, in embodiments of the disclosure, the first authorization revocation request is sent to the CAPIF core function/authorization function. In embodiments of the disclosure, the CAPIF core function/authorization function revokes the related token used for accessing resources of the UE based on the authorization revocation request sent by the API invoker, which may enable the CAPIF core function/authorization function to actively revoke the related token used for accessing resources of the UE, and thus reduce potential threats due to the token disclosure.

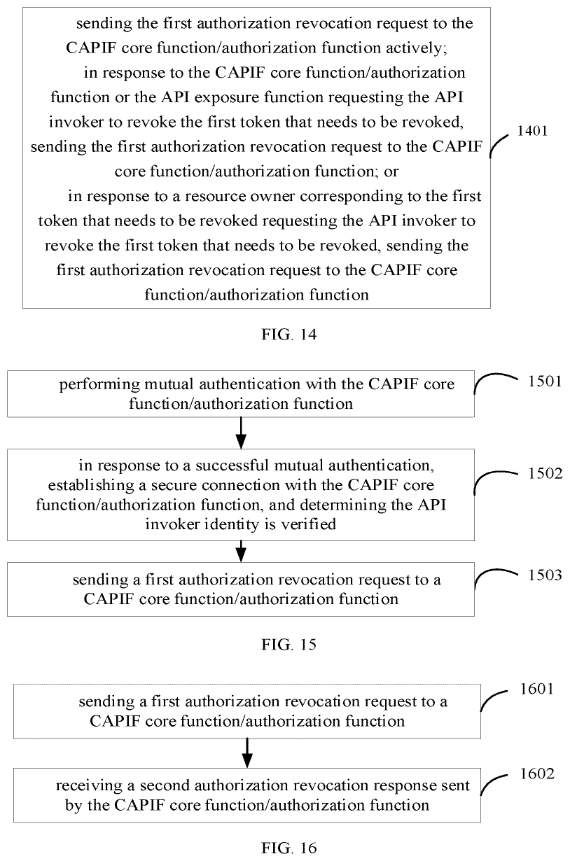

FIG. 14 is a flow chart illustrating a method for authorization revocation provided in an embodiment of the disclosure. The method is performed by an API invoker. As shown in FIG. 14, the method may include the following step 1401.

At step 1401, the first authorization revocation request is sent to the CAPIF core function/authorization function actively; or in response to the CAPIF core function/authorization function or the API exposure function requesting the API invoker to revoke the first token that needs to be revoked, the first authorization revocation request is sent to the CAPIF core function/authorization function; or in response to a resource owner corresponding to the first token that needs to be revoked requesting the API invoker to revoke the first token that needs to be revoked, the first authorization revocation request is sent to the CAPIF core function/authorization function.

In an embodiment of the disclosure, the API invoker triggers authorization revocation, i.e., send the first authorization revocation request to the CAPIF core function/authorization function actively, when the API invoker determines that the token, e.g., access token or refresh token, is under the potential threats of disclosure.

In an embodiment of the disclosure, the first authorization revocation request includes at least one of: an API invoker identity; a first token that needs to be revoked; or a token type corresponding to the first token that needs to be revoked.

In summary, in embodiments of the disclosure, the first authorization revocation request is sent to the CAPIF core function/authorization function actively; or in response to the CAPIF core function/authorization function or the API exposure function requesting the API invoker to revoke the first token that needs to be revoked, the first authorization revocation request is sent to the CAPIF core function/authorization function; or in response to a resource owner corresponding to the first token that needs to be revoked requesting the API invoker to revoke the first token that needs to be revoked, the first authorization revocation request is sent to the CAPIF core function/authorization function. In embodiments of the disclosure, the CAPIF core function/authorization function revokes the related token used for accessing resources of the UE based on the authorization revocation request sent by the API invoker, which may enable the CAPIF core function/authorization function to actively revoke the related token used for accessing resources of the UE, and thus reduce potential threats due to the token disclosure.

FIG. 15 is a flow chart illustrating a method for authorization revocation provided in an embodiment of the disclosure. The method is performed by an API invoker. As shown in FIG. 15, the method may include the following steps 1501 to 1503.

At step 1501, mutual authentication is performed with the CAPIF core function/authorization function.

At step 1502, in response to a successful mutual authentication, a secure connection with the CAPIF core function/authorization function is established, and it is determined that the API invoker identity is verified.

At step 1503, a first authorization revocation request is sent to the CAPIF core function/authorization function.

For example, in an embodiment of the disclosure, the first authorization revocation request includes at least one of: an API invoker identity; a first token that needs to be revoked; or a token type corresponding to the first token that needs to be revoked.

Optionally, in an embodiment of the disclosure, the CAPIF core function/authorization function and the API invoker can do mutual authentication by using at least one of the following authentication mechanisms:
a mutual authentication based on transport layer security pre-shared key ciphersuites (TLS-PSK), public key infrastructure (PKI), and OAuth token,
a generic bootstrapping architecture (GBA)-based authentication mechanism,
an authentication and key management for applications (AKMA)-based authentication mechanism, or
certificate-based authentication mechanism.

Optionally, in an embodiment of the disclosure, when the API invoker establishes a secure connection with the CAPIF core function/authorization function in response to the successful mutual authentication, the secure connection may be established via TLS.

In summary, in embodiments of the disclosure, the mutual authentication is performed with the CAPIF core function/authorization function; in response to the successful mutual authentication, the secure connection with the CAPIF core function/authorization function is established, and it is determined that the API invoker identity is verified; and the first authorization revocation request is sent to the CAPIF core function/authorization function. In embodiments of the disclosure, the CAPIF core function/authorization function revokes the related token used for accessing resources of the UE based on the authorization revocation request sent by the API invoker, which may enable the CAPIF core function/authorization function to actively revoke the related token used for accessing resources of the UE, and thus reduce potential threats due to the token disclosure.

FIG. 16 is a flow chart illustrating a method for authorization revocation provided in an embodiment of the disclosure. The method is performed by an API invoker. As shown in FIG. 16, the method may include the following steps 1601 to 1603.
At step 1601, a first authorization revocation request is sent to a CAPIF core function/authorization function.
At step 1602, a second authorization revocation response sent by the CAPIF core function/authorization function is received.

For example, in an embodiment of the disclosure, the first authorization revocation request includes at least one of: an API invoker identity; a first token that needs to be revoked; or a token type corresponding to the first token that needs to be revoked.

In summary, in embodiments of the disclosure, the first authorization revocation request is sent to the CAPIF core function/authorization function; and the second authorization revocation response sent by the CAPIF core function/authorization function is received. In embodiments of the disclosure, the CAPIF core function/authorization function revokes the related token used for accessing resources of the UE based on the authorization revocation request sent by the API invoker, which may enable the CAPIF core function/authorization function to actively revoke the related token used for accessing resources of the UE, and thus reduce potential threats due to the token disclosure.

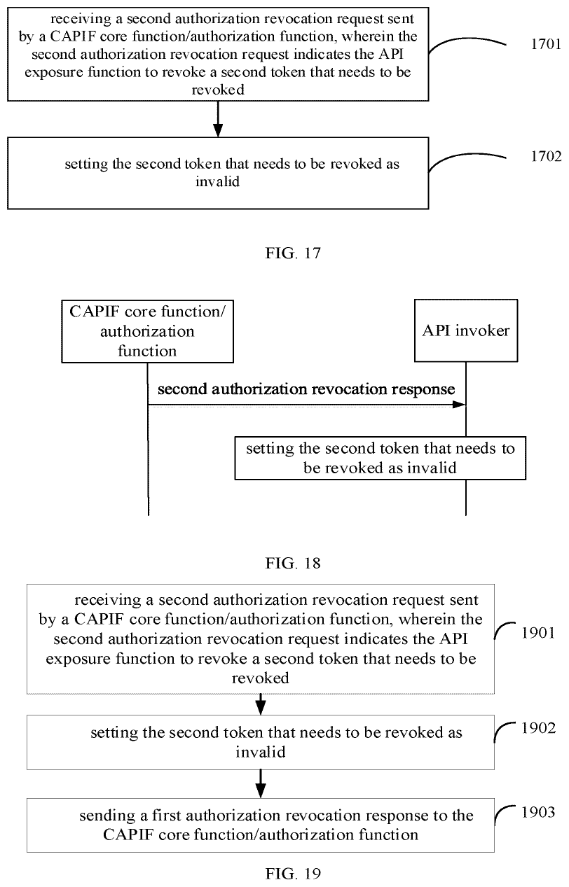

FIG. 17 is a flow chart illustrating a method for authorization revocation provided in an embodiment of the disclosure. The method is performed by an API exposure function. As shown in FIG. 17, the method may include the following steps 1701 to 1702.
At step 1701, a second authorization revocation request sent by a CAPIF core function/authorization function is received, in which the second authorization revocation request indicates the API exposure function to revoke a second token that needs to be revoked.
At step 1702, the second token that needs to be revoked is set as invalid.

For example, in an embodiment of the disclosure, when the API exposure function receives the second authorization revocation request sent by the CAPIF core function/authorization function, the API exposure function may also receive the second token that needs to be revoked sent by the CAPIF core function/authorization function.

In an embodiment of the disclosure, FIG. 18 is a schematic diagram illustrating an interaction of a method for authorization revocation provided in an embodiment of the disclosure. As shown in FIG. 18, the CAPIF core function/authorization function may send the second authorization revocation request to the API exposure function. When the API exposure function receives the second authorization revocation request sent by the CAPIF core function/authorization function, the API exposure function may set the second token that needs to be revoked to as invalid.

In summary, in embodiments of the disclosure, the second authorization revocation request sent by the CAPIF core function/authorization function is received, in which the second authorization revocation request indicates the API exposure function to revoke a second token that needs to be revoked; and the second token that needs to be revoked is set as invalid. In embodiments of the disclosure, the API exposure function revokes the related token used for accessing resources of the UE based on the authorization revocation request sent by the CAPIF core function/authorization function, which may enable the API exposure function to actively revoke the related token used for accessing resources of the UE, and thus reduce potential threats due to the token disclosure.

FIG. 19 is a flow chart illustrating a method for authorization revocation provided in an embodiment of the disclosure. The method is performed by an API exposure function. As shown in FIG. 19, the method may include the following steps 1901 to 1903.
At step 1901, a second authorization revocation request sent by a CAPIF core function/authorization function is received, in which the second authorization revocation request indicates the API exposure function to revoke a second token that needs to be revoked.
At step 1902, the second token that needs to be revoked is set as invalid.
At step 1903, a first authorization revocation response is sent to the CAPIF core function/authorization function.

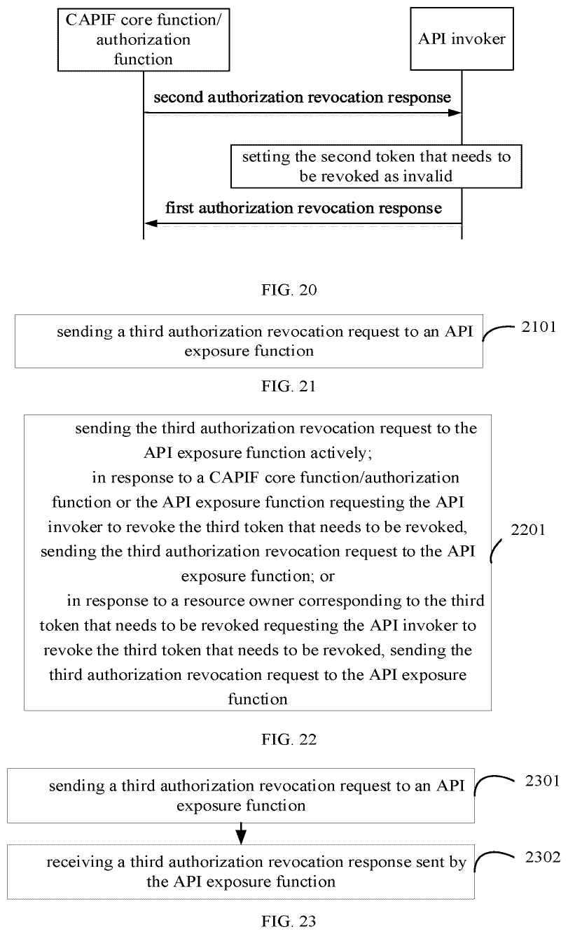

In an embodiment of the disclosure, FIG. 20 is a schematic diagram illustrating an interaction of a method for authorization revocation provided in an embodiment of the disclosure. As shown in FIG. 20, the CAPIF core function/authorization function may send the second authorization revocation request to the API exposure function. When the API exposure function receives the second authorization revocation request sent by the CAPIF core function/authorization function, the API exposure function may set the second token that needs to be revoked as invalid. The API exposure function may then send the first authorization revocation response to the CAPIF core function/authorization function.

In summary, in embodiments of the disclosure, the second authorization revocation request sent by the CAPIF core function/authorization function is received, in which the second authorization revocation request indicates the API exposure function to revoke a second token that needs to be revoked; the second token that needs to be revoked is set as invalid; and the first authorization revocation response is sent to the CAPIF core function/authorization function. In embodiments of the disclosure, the API exposure function revokes the related token used for accessing resources of the UE based on the authorization revocation request sent by the CAPIF core function/authorization function, which may enable the API exposure function to actively revoke the related token used for accessing resources of the UE, and thus reduce potential threats due to the token disclosure.

FIG. 21 is a flow chart illustrating a method for authorization revocation provided in an embodiment of the disclosure. The method is performed by an API invoker. As shown in FIG. 21, the method may include the following step 2101.

At step 2101, a third authorization revocation request is sent to an API exposure function.

In an embodiment of the disclosure, the API invoker may be a UE or an AF in SNA scenarios. The API invoker may obtain API invocation authorization information from the UE or the CAPFI core function/authorization function. With the API exposure function, the API invoker can trigger a specific API to obtain or update a specific resource of the UE.

Optionally, in an embodiment of the disclosure, the specific resource includes at least one of: location information of the UE; or QoS information of the UE.

Optionally, in an embodiment of the disclosure, the API invocation authorization information includes at least one of: an access token; or a refresh token.

For example, in an embodiment of the disclosure, the third authorization revocation request includes authorization information that needs to be revoked.

For example, in an embodiment of the disclosure, the third authorization revocation request includes at least one of: an API invoker identity; or a third token that needs to be revoked.

In summary, in embodiments of the disclosure, the third authorization revocation request is sent to the API exposure function. In embodiments of the disclosure, the API exposure function revokes the related token used for accessing resources of the UE based on the authorization revocation request sent by the API invoker, which may enable the API exposure function to actively revoke the related token used for accessing resources of the UE, and thus reduce potential threats due to the token disclosure.

FIG. 22 is a flow chart illustrating a method for authorization revocation provided in an embodiment of the disclosure. The method is performed by an API invoker. As shown in FIG. 22, the method may include the following step 2101.

At step 2201, the third authorization revocation request is sent to the API exposure function actively; or in response to a CAPIF core function/authorization function or the API exposure function requesting the API invoker to revoke the third token that needs to be revoked, the third authorization revocation request is sent to the API exposure function; or in response to a resource owner corresponding to the third token that needs to be revoked requesting the API invoker to revoke the third token that needs to be revoked, the third authorization revocation request is sent to the API exposure function.

For example, in an embodiment of the disclosure, the third authorization revocation request includes at least one of: an API invoker identity; or a third token that needs to be revoked.

In an embodiment of the disclosure, the API invoker triggers authorization revocation, i.e., send the third authorization revocation request to the API exposure function actively, when the API invoker determines that the token, e.g., access token or refresh token, is under the potential threats of disclosure.

In summary, in embodiments of the disclosure, the third authorization revocation request is sent to the API exposure function actively; or in response to the CAPIF core function/authorization function or the API exposure function requesting the API invoker to revoke the third token that needs to be revoked, the third authorization revocation request is sent to the API exposure function; or in response to the resource owner corresponding to the third token that needs to be revoked requesting the API invoker to revoke the third token that needs to be revoked, the third authorization revocation request is sent to the API exposure function. In embodiments of the disclosure, the API exposure function revokes the related token used for accessing resources of the UE based on the authorization revocation request sent by the API invoker, which may enable the API exposure function to actively revoke the related token used for accessing resources of the UE, and thus reduce potential threats due to the token disclosure.

FIG. 23 is a flow chart illustrating a method for authorization revocation provided in an embodiment of the disclosure. The method is performed by an API invoker. As shown in FIG. 23, the method may include the following steps 2301 to 2302.
At step 2301, a third authorization revocation request is sent to an API exposure function.
At step 2302, a third authorization revocation response sent by the API exposure function is received.

For example, in an embodiment of the disclosure, the third authorization revocation request includes at least one of: an API invoker identity; or a third token that needs to be revoked.

In summary, in embodiments of the disclosure, the third authorization revocation request is sent to the API exposure function; and the third authorization revocation response sent by the API exposure function is received. In embodiments of the disclosure, the API exposure function revokes the related token used for accessing resources of the UE based on the authorization revocation request sent by the API invoker, which may enable the API exposure function to actively revoke the related token used for accessing resources of the UE, and thus reduce potential threats due to the token disclosure.

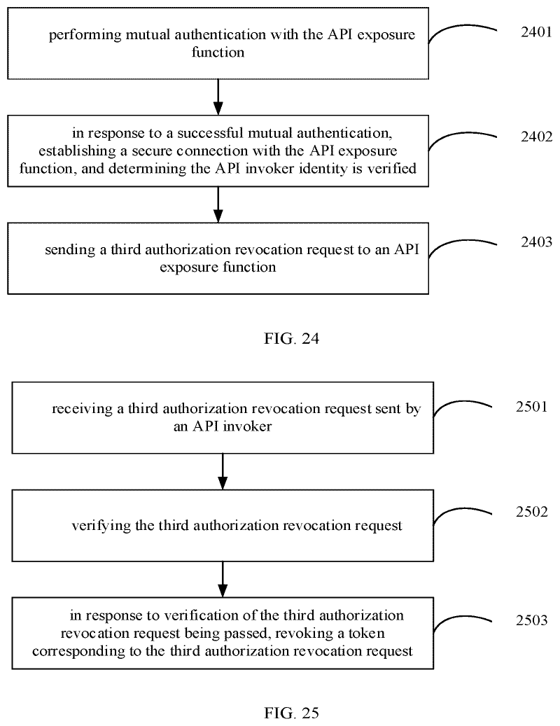

FIG. 24 is a flow chart illustrating a method for authorization revocation provided in an embodiment of the disclosure. The method is performed by an API invoker. As shown in FIG. 24, the method may include the following steps 2401 to 2403.
At step 2401, mutual authentication with the API exposure function is performed.
At step 2402, in response to a successful mutual authentication, a secure connection with the API exposure function is established, and it is determined that the API invoker identity is verified.
At step 2403, a third authorization revocation request is sent to the API exposure function.

Optionally, in an embodiment of the disclosure, the API exposure function and the API invoker can do mutual authentication by using at least one of the following authentication mechanisms:
a mutual authentication based on transport layer security pre-shared key ciphersuites (TLS-PSK), public key infrastructure (PKI), and OAuth token,
a generic bootstrapping architecture (GBA)-based authentication mechanism,
an authentication and key management for applications (AKMA)-based authentication mechanism, or
certificate-based authentication mechanism.

Optionally, in an embodiment of the disclosure, when the API invoker establishes a secure connection with the API exposure function in response to the successful mutual authentication, the secure connection may be established via TLS.

For example, in an embodiment of the disclosure, the third authorization revocation request includes at least one of: an API invoker identity; or a third token that needs to be revoked.

In summary, in embodiments of the disclosure, the mutual authentication with the API exposure function is performed; in response to the successful mutual authentication, the secure connection with the API exposure function is established, and it is determined that the API invoker identity is verified; and a third authorization revocation request is sent to the API exposure function. In embodiments of the disclosure, the API exposure function revokes the related token used for accessing resources of the UE based on the authorization revocation request sent by the API invoker, which may enable the API exposure function to actively revoke the related token used for accessing resources of the UE, and thus reduce potential threats due to the token disclosure.

FIG. 25 is a flow chart illustrating a method for authorization revocation provided in an embodiment of the disclosure. The method is performed by an API exposure function. As shown in FIG. 25, the method may include the following steps 2501 to 2503.
At step 2501, a third authorization revocation request sent by an API invoker is received.
At step 2502, the third authorization revocation request is verified.
At step 2503, in response to verification of the third authorization revocation request being passed, a token corresponding to the third authorization revocation request is revoked.

In an embodiment of the disclosure, the API invoker may be a UE or an AF in SNA scenarios. The API invoker may obtain API invocation authorization information from the UE or the CAPFI core function/authorization function. With the API exposure function, the API invoker can trigger a specific API to obtain or update a specific resource of the UE.

Optionally, in an embodiment of the disclosure, the specific resource includes at least one of: location information of the UE; or QoS information of the UE.

Optionally, in an embodiment of the disclosure, the API invocation authorization information includes at least one of: an access token; or a refresh token.

For example, in an embodiment of the disclosure, the token corresponding to the third authorization revocation request includes at least one of the following information: a token type, such as an access token, a refresh token, and etc.; a CAPIF core function identity; a CAPIF authorization function identity; an API invoker identity; a UE identity; an API exposure function identity; a service API identifier; a service identifier; a service operation identifier; a target resource identifier; a geographic area; or an expired time.

For example, in an embodiment of the disclosure, the first authorization revocation request includes authorization information that needs to be revoked.

For example, in an embodiment of the disclosure, the third authorization revocation request includes at least one of: an API invoker identity; or a third token that needs to be revoked.

In an embodiment of the disclosure, the third authorization revocation request may further include a token type corresponding to the first token that needs to be revoked.

For example, in an embodiment of the disclosure, when the API exposure function revokes the token corresponding to the third authorization revocation request, the token corresponding to the third authorization revocation request will be invalid.

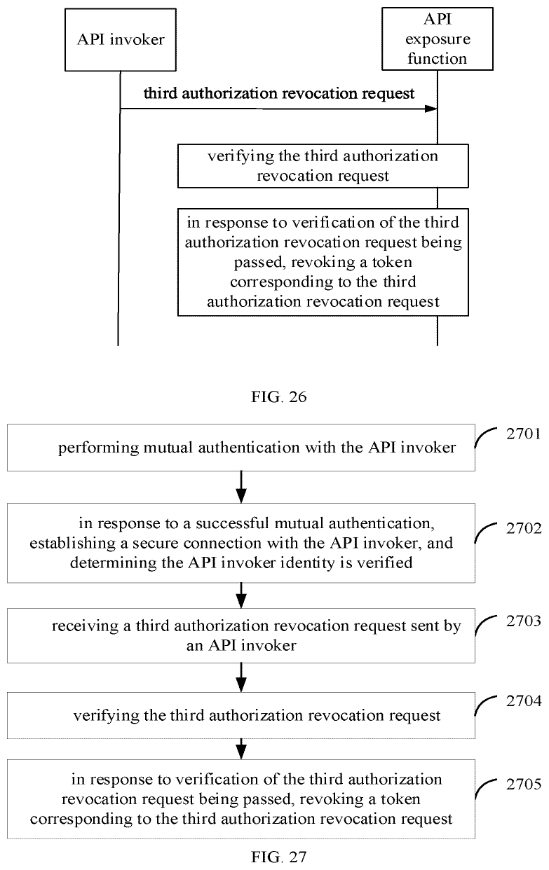

In an embodiment of the disclosure, FIG. 26 is a schematic diagram illustrating an interaction of a method for authorization revocation provided in an embodiment of the disclosure. As shown in FIG. 26, the API invoker may send the third authorization revocation request to the API exposure function. When the API exposure function receives the third authorization revocation request, the API exposure function may verify the third authorization revocation request. If the API exposure function determines that verification of the third authorization revocation request is passed, the API exposure function may revoke the token corresponding to the third authorization revocation request.

In summary, in embodiments of the disclosure, the third authorization revocation request sent by the API invoker is received; the third authorization revocation request is verified; and in response to verification of the third authorization revocation request being passed, the token corresponding to the third authorization revocation request is revoked. In embodiments of the disclosure, the API exposure function revokes the related token used for accessing resources of the UE based on the authorization revocation request sent by the API invoker, which may enable the API exposure function to actively revoke the related token used for accessing resources of the UE, and thus reduce potential threats due to the token disclosure.

FIG. 27 is a flow chart illustrating a method for authorization revocation provided in an embodiment of the disclosure. The method is performed by an API exposure function. As shown in FIG. 27, the method may include the following steps 2701 to 2705.
At step 2701, mutual authentication with an API invoker is performed.
At step 2702, in response to a successful mutual authentication, a secure connection with the API invoker is established, and it is determined that the API invoker identity is verified.
At step 2703, a third authorization revocation request sent by the API invoker is received.
At step 2704, the third authorization revocation request is verified.
At step 2705, in response to verification of the third authorization revocation request being passed, a token corresponding to the third authorization revocation request is revoked.

For example, in an embodiment of the disclosure, the third authorization revocation request includes at least one of: an API invoker identity; or a third token that needs to be revoked.

Optionally, in an embodiment of the disclosure, the API explosure function and the API invoker can do mutual authentication by using at least one of the following authentication mechanisms:
a mutual authentication based on transport layer security pre-shared key ciphersuites (TLS-PSK), public key infrastructure (PKI), and OAuth token,
a generic bootstrapping architecture (GBA)-based authentication mechanism,
an authentication and key management for applications (AKMA)-based authentication mechanism, or
certificate-based authentication mechanism.

Optionally, in an embodiment of the disclosure, when the API exposure function establishes a secure connection with the API invoker in response to the successful mutual authentication, the secure connection may be established via TLS.

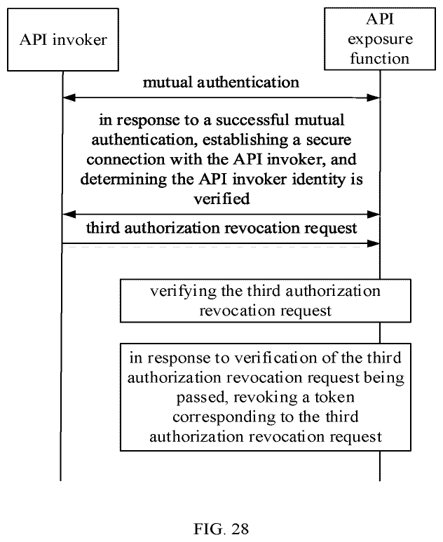

In an embodiment of the disclosure, FIG. 28 is a schematic diagram illustrating an interaction of a method for authorization revocation provided in an embodiment of the disclosure. As shown in FIG. 28, the API exposure function may perform mutual authentication with the API invoker, and in response to the successful mutual authentication, the API exposure function may establish the secure connection with the API invoker, and determine the API invoker identity is verified. The API invoker may then send the third authorization revocation request to the API exposure function. When the API exposure function receives the third authorization revocation request, the API exposure function may verify the third authorization revocation request. If the API exposure function determines that verification of the third authorization revocation request is passed, the API exposure function may revoke the token corresponding to the third authorization revocation request.

In summary, in embodiments of the disclosure, the mutual authentication with the API invoker is performed; in response to the successful mutual authentication, the secure connection with the API invoker is established, and it is determined that the API invoker identity is verified; the third authorization revocation request sent by the API invoker is received; the third authorization revocation request is verified; and in response to verification of the third authorization revocation request being passed, the token corresponding to the third authorization revocation request is revoked. In embodiments of the disclosure, the API exposure function revokes the related token used for accessing resources of the UE based on the authorization revocation request sent by the API invoker, which may enable the API exposure function to actively revoke the related token used for accessing resources of the UE, and thus reduce potential threats due to the token disclosure.

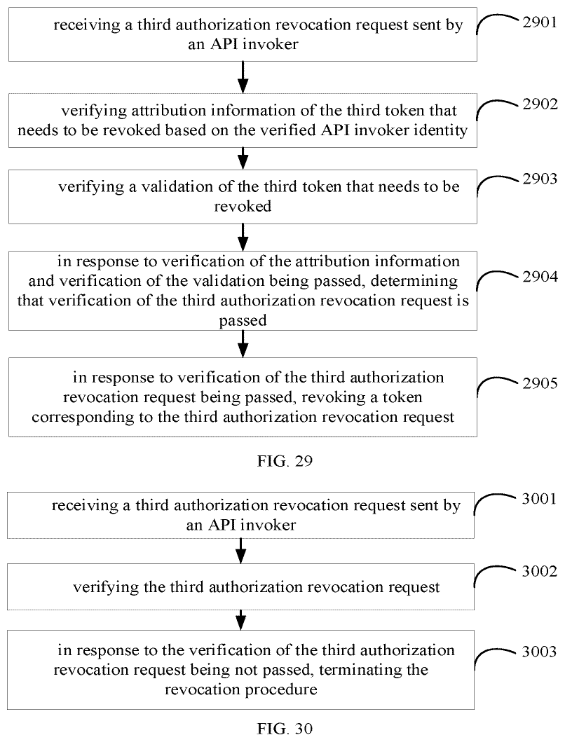

FIG. 29 is a flow chart illustrating a method for authorization revocation provided in an embodiment of the disclosure. The method is performed by an API exposure function. As shown in FIG. 29, the method may include the following steps 2901 to 2905.
At step 2901, a third authorization revocation request sent by the API invoker is received.
At step 2902, attribution information of the third token that needs to be revoked is verified based on the verified API invoker identity.
At step 2903, a validation of the third token that needs to be revoked is verified.
At step 2904, in response to verification of the attribution information and verification of the validation being passed, it is determined that verification of the third authorization revocation request is passed.
At step 2905, in response to verification of the third authorization revocation request being passed, a token corresponding to the third authorization revocation request is revoked.

For example, in an embodiment of the disclosure, the third authorization revocation request includes at least one of: an API invoker identity; or a third token that needs to be revoked.

Optionally, in an embodiment of the disclosure, when the API exposure function verifies the attribution information of the third token that needs to be revoked based on the verified API invoker identity, the API exposure function may verify the attribution information of the third token that needs to be revoked by: determining whether the verified API invoker identity is identical to the API invoker identity corresponding to the third token that needs to be revoked, or determining whether the verified API invoker identity may be mapped to the API invoker identity corresponding to the third token that needs to be revoked.

Optionally, in an embodiment of the disclosure, if the verified API invoker identity is identical to the API invoker identity corresponding to the third token that needs to be revoked, or if the verified API invoker identity may be mapped to the API invoker identity corresponding to the third token that needs to be revoked, it is indicated that the verification of the attribution information of the third token that needs to be revoked is passed.

Optionally, in an embodiment of the disclosure, the API exposure function may perform mutual authentication with the API invoker. In response to a successful mutual authentication, the API exposure function may establish a secure connection with the API invoker, and determine the API invoker identity is verified.

Optionally, in an embodiment of the disclosure, when the API exposure function verifies a validation of the third token that needs to be revoked, the API exposure function may send the third token that needs to be revoked to the CAPIF core function/authorization function to verify the validation of the third token that needs to be revoked. Thus, the CAPIF core function/authorization function may leverage a public key or a local policy to verify an integrity of the third token that needs to be revoked. If the verification result indicates that the third token that needs to be revoked is not modified, the third token that needs to be revoked is valid. If the verification result indicates that the third token that needs to be revoked is modified, the third token that needs to be revoked is invalid.

In an embodiment of the disclosure, the API exposure function may further leverage a public key of the CAPIF core function/authorization function to verify the validation of the third token that needs to be revoked.

For example, in an embodiment of the disclosure, the third authorization revocation request includes at least one of: an API invoker identity; or a third token that needs to be revoked.

In summary, in embodiments of the disclosure, the third authorization revocation request sent by the API invoker is received; attribution information of the third token that needs to be revoked is verified based on the verified API invoker identity; the validation of the third token that needs to be revoked is verified; in response to verification of the attribution information and verification of the validation being passed, it is determined that verification of the third authorization revocation request is passed, and in response to verification of the third authorization revocation request being passed, the token corresponding to the third authorization revocation request is revoked. In embodiments of the disclosure, the API exposure function revokes the related token used for accessing resources of the UE based on the authorization revocation request sent by the API invoker, which may enable the API exposure function to actively revoke the related token used for accessing resources of the UE, and thus reduce potential threats due to the token disclosure.

FIG. 30 is a flow chart illustrating a method for authorization revocation provided in an embodiment of the disclosure. The method is performed by an API exposure function. As shown in FIG. 30, the method may include the following steps 3001 to 3003.
At step 3001, a third authorization revocation request sent by the API invoker is received.
At step 3002, the third authorization revocation request is verified.
At step 3003, in response to the verification of the third authorization revocation request being not passed, the revocation procedure is terminated.

For example, in an embodiment of the disclosure, the third authorization revocation request includes at least one of: an API invoker identity; or a third token that needs to be revoked.

In summary, in embodiments of the disclosure, the third authorization revocation request sent by the API invoker is received; the third authorization revocation request is verified; and in response to the verification of the third authorization revocation request being not passed, the revocation procedure is terminated. In embodiments of the disclosure, the API exposure function revokes the related token used for accessing resources of the UE based on the authorization revocation request sent by the API invoker, which may enable the API exposure function to actively revoke the related token used for accessing resources of the UE, and thus reduce potential threats due to the token disclosure.

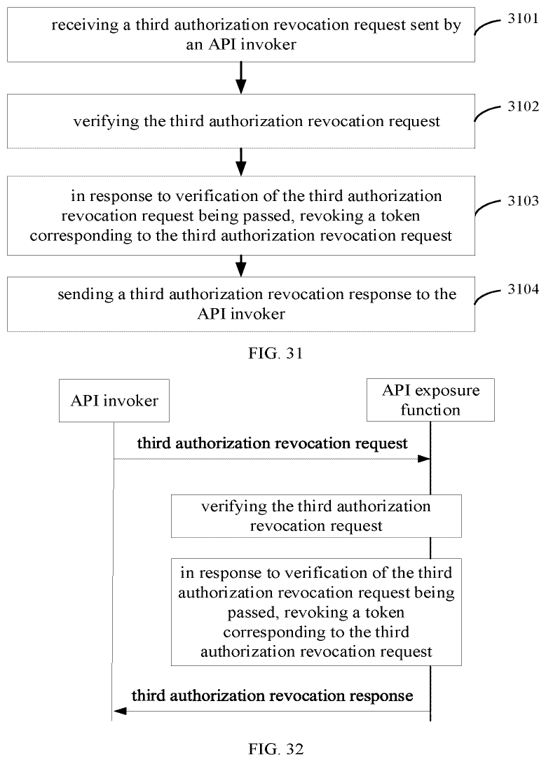

FIG. 31 is a flow chart illustrating a method for authorization revocation provided in an embodiment of the disclosure. The method is performed by an API exposure function. As shown in FIG. 31, the method may include the following steps 3101 to 3104.
At step 3101, a third authorization revocation request sent by the API invoker is received.
At step 3102, the third authorization revocation request is verified.
At step 3103, in response to verification of the third authorization revocation request being passed, a token corresponding to the third authorization revocation request is revoked.
At step 3104, a third authorization revocation response is sent to the API invoker.

For example, in an embodiment of the disclosure, the third authorization revocation request includes at least one of: an API invoker identity; or a third token that needs to be revoked.

In an embodiment of the disclosure, FIG. 32 is a schematic diagram illustrating an interaction of a method for authorization revocation provided in an embodiment of the disclosure. As shown in FIG. 32, the API invoker may send the third authorization revocation request to the API exposure function. When the API exposure function receives the third authorization revocation request, the API exposure function may verify the third authorization revocation request. If the API exposure function determines that verification of the third authorization revocation request is passed, the API exposure function may revoke the token corresponding to the third authorization revocation request. The API exposure function may send the third authorization revocation response to the API invoker.

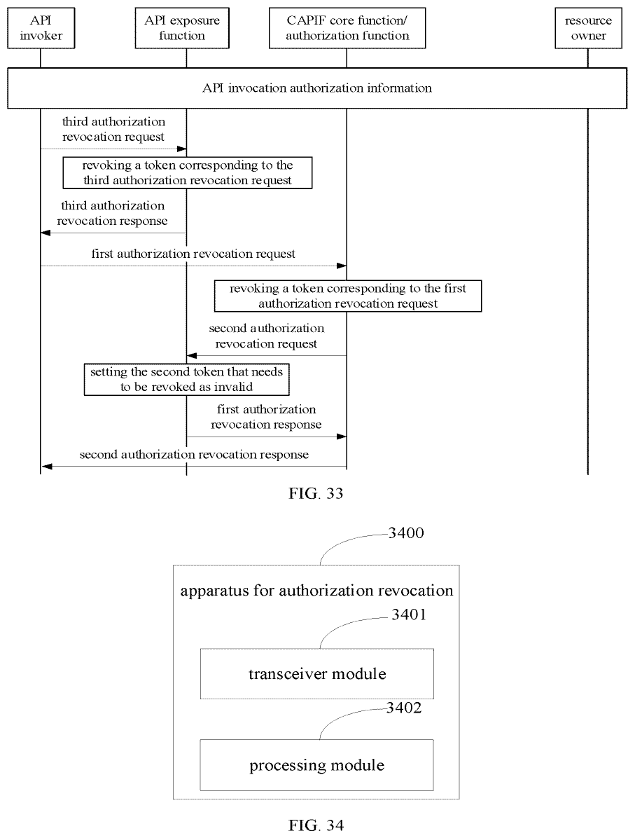

In an embodiment of the disclosure, FIG. 33 is a schematic diagram illustrating an interaction of a method for authorization revocation provided in an embodiment of the disclosure. As shown in FIG. 33, the API invoker, the API exposure function, and the CAPIF core function/authorization function may access resources in the resource owner via API invoker authorization information. The API invoker may send the third authorization revocation request to the API exposure function. Then, the API exposure function may revoke the token corresponding to the third authorization revocation request, and send the third authorization revocation response to the API invoker. At the same time, the API invoker may further send the first authorization revocation request to the CAPIF core function/authorization function. Then, the CAPIF core function/authorization function may revoke the token corresponding to the first authorization revocation request, and send the second authorization revocation request to the API exposure function, so that the API exposure function may set the second token that needs to be revoked as invalid, and send the first authorization revocation response to the CAPIF core function/authorization function. Finally, the CAPIF core function/authorization function may send the second authorization revocation response to the API invoker.

In summary, in embodiments of the disclosure, the third authorization revocation request sent by the API invoker is received; the third authorization revocation request is verified; in response to verification of the third authorization revocation request being passed, the token corresponding to the third authorization revocation request is revoked; and the third authorization revocation response is sent to the API invoker. In embodiments of the disclosure, the API exposure function revokes the related token used for accessing resources of the UE based on the authorization revocation request sent by the API invoker, which may enable the API exposure function to actively revoke the related token used for accessing resources of the UE, and thus reduce potential threats due to the token disclosure.

FIG. 34 is a structural block diagram illustrating an apparatus for authorization revocation provided in an embodiment of the disclosure. As shown in FIG. 34, the apparatus 3400 may be configured on a CAPIF core function/authorization function side. The apparatus 3400 may include a transceiver module 3401 and a processing module 3402.
The transceiver module 3401 is configured to receive a first authorization revocation request sent by an API invoker.
The processing module 3402 is configured to verify the first authorization revocation request.
The processing module 3402 is further configured to, in response to verification of the first authorization revocation request being passed, revoke a token corresponding to the first authorization revocation request.

In summary, in the apparatus for authorization revocation in embodiments of the disclosure, the transceiver module is configured to receive the first authorization revocation request sent by the API invoker. The processing module is configured to verify the first authorization revocation request and, in response to verification of the first authorization revocation request being passed, revoke the token corresponding to the first authorization revocation request. In embodiments of the disclosure, the CAPIF core function/authorization function revokes the related token used for accessing resources of the UE based on the authorization revocation request sent by the API invoker, which may enable the CAPIF core function/authorization function to actively revoke the related token used for accessing resources of the UE, and thus reduce potential threats due to the token disclosure.

Optionally, in an embodiment of the disclosure, when verifying the first authorization revocation request, the processing module 3402 is specifically configured to revoke the token corresponding to the first authorization revocation request from the CAPIF core function/authorization function; and revoke the token corresponding to the first authorization revocation request from an API exposure function.

Optionally, in an embodiment of the disclosure, the first authorization revocation request includes at least one of: an API invoker identity; a first token that needs to be revoked; or a token type corresponding to the first token that needs to be revoked.

Optionally, in an embodiment of the disclosure, the processing module 3402 is further configured to perform mutual authentication with the API invoker; and in response to a successful mutual authentication, establish a secure connection with the API invoker, and determine the API invoker identity is verified.

Optionally, in an embodiment of the disclosure, when revoking the token corresponding to the first authorization revocation request from the API exposure function, the processing module 3402 is specifically configured to determine a second token that needs to be revoked based on the first token that needs to be revoked and the token type; and send a second authorization revocation request to the API exposure function, in which the second authorization revocation request indicates the API exposure function to revoke the second token that needs to be revoked.

Optionally, in an embodiment of the disclosure, when verifying the first authorization revocation request, the processing module 3402 is specifically configured to verify attribution information of the first token that needs to be revoked based on the verified API invoker identity; verify a validation of the first token that needs to be revoked; and in response to verification of the attribution information and verification of the validation being passed, determine that verification of the first authorization revocation request is passed.

Optionally, in an embodiment of the disclosure, when verifying the attribution information of the first token that needs to be revoked based on the verified API invoker identity, the processing module 3402 is specifically configured to, in response to the verified API invoker identity being identical to an API invoker identity corresponding to the first token that needs to be revoked, determine that the verification of the attribution information of the first token that needs to be revoked is passed; or in response to determining that the verified API invoker identity may be mapped to the API invoker identity, determining that the verification of the attribution information of the first token that needs to be revoked is passed.

Optionally, in an embodiment of the disclosure, when verifying the validation of the first token that needs to be revoked, the processing module 3402 is specifically configured to verify the validation of the first token that needs to be revoked using a public key.

Optionally, In an embodiment of the disclosure, when determining the second token that needs to be revoked based on the first token that needs to be revoked and the token type, the processing module 3402 is specifically configured to in response to the first token that needs to be revoked being an access token, use the first token that needs to be revoked as the second token that needs to be revoked; or in response to the first token that needs to be revoked being a refresh token, use an access token corresponding to the first token that needs to be revoked as the second token that needs to be revoked.

Optionally, in an embodiment of the disclosure, the processing module 3402 is further configured to in response to verification of the first authorization revocation request being not passed, terminate the revocation procedure.

Optionally, in an embodiment of the disclosure, the transceiver module 3401 is further configured to receive a first authorization revocation response fed back by the API exposure function; and send a second authorization revocation response to the API invoker.

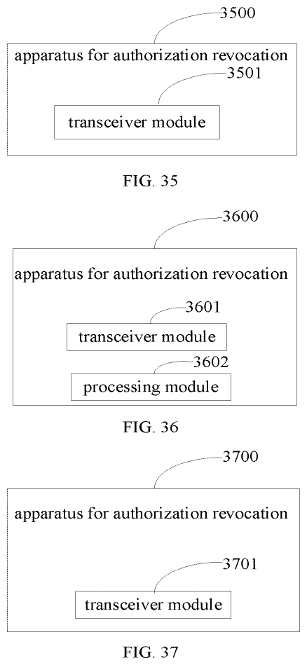

FIG. 35 is a structural block diagram illustrating an apparatus for authorization revocation provided in an embodiment of the disclosure. As shown in FIG. 35, the apparatus 3500 may be configured on an API invoker side. The apparatus 3500 may include a transceiver module 3501.

The transceiver module 3501 is configured to send a first authorization revocation request to a CAPIF core function/authorization function.

In summary, in the apparatus for authorization revocation in embodiments of the disclosure, the transceiver module is configured to send the first authorization revocation request to the CAPIF core function/authorization function. In embodiments of the disclosure, the CAPIF core function/authorization function revokes the related token used for accessing resources of the UE based on the authorization revocation request sent by the API invoker, which may enable the CAPIF core function/authorization function to actively revoke the related token used for accessing resources of the UE, and thus reduce potential threats due to the token disclosure.

Optionally, in an embodiment of the disclosure, the first authorization revocation request includes at least one of: an API invoker identity; a first token that needs to be revoked; or a token type corresponding to the first token that needs to be revoked.

Optionally, in an embodiment of the disclosure, when sending the first authorization revocation request to the CAPIF core function/authorization function, the transceiver module 3501 is specifically configured to send the first authorization revocation request to the CAPIF core function/authorization function actively; in response to the CAPIF core function/authorization function or the API exposure function requesting the API invoker to revoke the first token that needs to be revoked, send the first authorization revocation request to the CAPIF core function/authorization function; or in response to a resource owner corresponding to the first token that needs to be revoked requesting the API invoker to revoke the first token that needs to be revoked, send the first authorization revocation request to the CAPIF core function/authorization function.

Optionally, in an embodiment of the disclosure, the transceiver module 3501 is further configured to perform mutual authentication with the CAPIF core function/authorization function; and in response to a successful mutual authentication, establish a secure connection with the CAPIF core function/authorization function, and determine the API invoker identity is verified.

Optionally, in an embodiment of the disclosure, the transceiver module 3501 is further configured to receive a second authorization revocation response sent by the CAPIF core function/authorization function.

FIG. 36 is a structural block diagram illustrating an apparatus for authorization revocation provided in an embodiment of the disclosure. As shown in FIG. 36, the apparatus 3600 may be configured on an API exposure function side. The apparatus 3600 may include a transceiver module 3601 and a processing module 3602.

The transceiver module 3601 is configured to receive a second authorization revocation request sent by a CAPIF core function/authorization function, in which the second authorization revocation request indicates the API exposure function to revoke a second token that needs to be revoked.

The processing module 3602 is configured to set the second token that needs to be revoked as invalid.

In summary, in the apparatus for authorization revocation in embodiments of the disclosure, the transceiver module is configured to receive the second authorization revocation request sent by the CAPIF core function/authorization function, in which the second authorization revocation request indicates the API exposure function to revoke the second token that needs to be revoked. The processing module is configured to set the second token that needs to be revoked as invalid. In embodiments of the disclosure, the API exposure function revokes the related token used for accessing resources of the UE based on the authorization revocation request sent by the CAPIF core function/authorization function, which may enable the API exposure function to actively revoke the related token used for accessing resources of the UE, and thus reduce potential threats due to the token disclosure.

Optionally, in an embodiment of the disclosure, the transceiver module 3601 is further configured to send a first authorization revocation response to the CAPIF core function/authorization function.

FIG. 37 is a structural block diagram illustrating an apparatus for authorization revocation provided in an embodiment of the disclosure. As shown in FIG. 37, the apparatus 3700 may be configured on an API invoker side. The apparatus 3700 may include a transceiver module 3701.

The transceiver module 3701 is configured to send a third authorization revocation request to an API exposure function.

In summary, in the apparatus for authorization revocation in embodiments of the disclosure, the transceiver module is configured to send the third authorization revocation request to the API exposure function. In embodiments of the disclosure, the API exposure function revokes the related token used for accessing resources of the UE based on the authorization revocation request sent by the API invoker, which may enable the API exposure function to actively revoke the related token used for accessing resources of the UE, and thus reduce potential threats due to the token disclosure.

Optionally, in an embodiment of the disclosure, the third authorization revocation request includes at least one of: an API invoker identity; or a third token that needs to be revoked.

Optionally, in an embodiment of the disclosure, when sending the third authorization revocation request to the API exposure function, the transceiver module 3701 is specifically configured to send the third authorization revocation request to the API exposure function actively; in response to a CAPIF core function/authorization function or the API exposure function requesting the API invoker to revoke the third token that needs to be revoked, send the third authorization revocation request to API exposure function; or in response to a resource owner corresponding to the third token that needs to be revoked requesting the API invoker to revoke the third token that needs to be revoked, send the third authorization revocation request to the API exposure function.

Optionally, in an embodiment of the disclosure, the transceiver module 3701 is further configured to receive a third authorization revocation response sent by the API exposure function.

Optionally, in an embodiment of the disclosure, the transceiver module 3701 is further configured to perform mutual authentication with the API exposure function; and in response to a successful mutual authentication, establish a secure connection with the API exposure function, and determine the API invoker identity is verified.

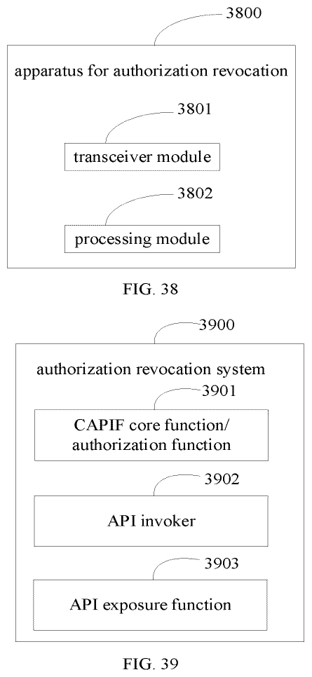

FIG. 38 is a structural block diagram illustrating an apparatus for authorization revocation provided in an embodiment of the disclosure. As shown in FIG. 38, the apparatus 3800 may be configured on an API invoker side. The apparatus 3600 may include a transceiver module 3801 and a processing module.

The transceiver module 3801 is configured to receive a third authorization revocation request sent by an API invoker.

The processing module 3802 is configured to verify the third authorization revocation request.

The processing module 3802 is further configured to, in response to verification of the third authorization revocation request being passed, revoke a token corresponding to the third authorization revocation request.

In summary, in the apparatus for authorization revocation in embodiments of the disclosure, the transceiver module is configured to receive the third authorization revocation request sent by the API invoker. The processing module is configured to verify the third authorization revocation request and, in response to verification of the third authorization revocation request being passed, revoke the token corresponding to the third authorization revocation request. In embodiments of the disclosure, the API exposure function revokes the related token used for accessing resources of the UE based on the authorization revocation request sent by the API invoker, which may enable the API exposure function to actively revoke the related token used for accessing resources of the UE, and thus reduce potential threats due to the token disclosure.

Optionally, in an embodiment of the disclosure, the processing module 3802 is further configured to perform mutual authentication with the API invoker; and in response to a successful mutual authentication, establish a secure connection with the API invoker, and determine the API invoker identity is verified.

Optionally, in an embodiment of the disclosure, the third authorization revocation request includes at least one of: an API invoker identity; or a third token that needs to be revoked.

Optionally, in an embodiment of the disclosure, when verifying the third authorization revocation request, the processing module 3802 is specifically configured to verify attribution information of the third token that needs to be revoked based on the verified API invoker identity; verify a validation of the third token that needs to be revoked; and in response to verification of the attribution information and verification of the validation being passed, determine that verification of the third authorization revocation request is passed.

Optionally, in an embodiment of the disclosure, when verifying the attribution information of the third token that needs to be revoked based on the verified API invoker identity, the processing module 3802 is specifically configured to in response to the verified API invoker identity being identical to an API invoker identity corresponding to the third token that needs to be revoked, determine that the verification of the attribution information of the third token that needs to be revoked is passed; or in response to determining that the verified API invoker identity may be mapped to the API invoker identity, determine that the verification of the attribution information of the third token that needs to be revoked is passed.

Optionally, in an embodiment of the disclosure, when verifying the validation of the third token that needs to be revoked, the processing module 3802 is specifically configured to verify the validation of the third token that needs to be revoked by sending the third token that needs to be revoked to a CAPIF core function/authorization function, or verify the validation of the third token that needs to be revoked using a public key of the CAPIF core function/authorization function.

Optionally, in an embodiment of the disclosure, the processing module 3802 is further configured to, in response to the verification of the third authorization revocation request being not passed, terminating the revocation procedure.

Optionally, in an embodiment of the disclosure, the transceiver module 3801 is further configured to send a third authorization revocation response to the API invoker.

FIG. 39 is a structural block diagram illustrating a system for authorization revocation provided in an embodiment of the disclosure. As shown in FIG. 39, the system 3900 includes a CAPIF core function/authorization function 3901, an API invoker 3902 and an API exposure function 3903.

The CAPIF core function/authorization function 3901 is configured to perform the method as illustrated in any one of FIG. 1 to FIG. 12.

The API invoker 3902 is configured to perform the method as illustrated in any one of FIG. 13 to FIG. 16 or FIG. 21 to FIG. 24.

The API exposure function 3903 is configured to perform the method as illustrated in any one of FIG. 17 to FIG. 20 or FIG. 25 to FIG. 33.

The disclosure provides a processing system for the situation “authorization revocation”, which enables the CAPIF core function/authorization function to revoke the related token used for accessing resources of the UE based on the authorization revocation request sent by the API invoker, and thus reduce potential threats due to the token disclosure.

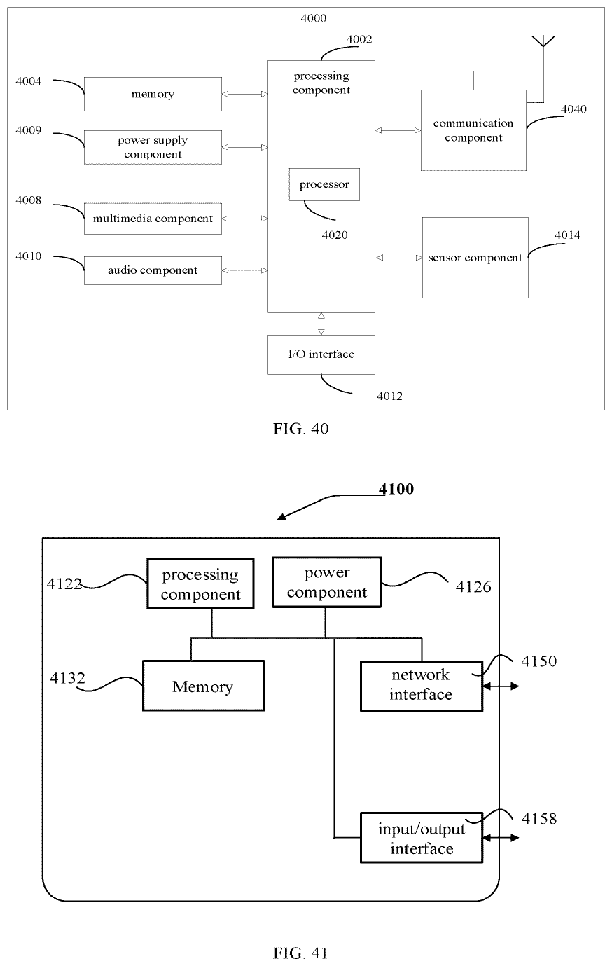

FIG. 40 is a block diagram illustrating a UE 4000 for authorization revocation provided in an embodiment of the disclosure. For example, the UE 4000 may be a cell phone, a computer, a digital broadcast terminal, a message transceiver device, a game console, a tablet device, a medical device, a fitness device, a personal digital assistant, and the like.

Referring to FIG. 40, the UE 4000 may include one or more of the following components: a processing component 4002, a memory 4004, a power supply component 4006, a multimedia component 4008, an audio component 4010, an input/output (I/O) interface 4012, a sensor component 4014, and a communication component 4016.

The processing component 4002 generally controls overall operations of the UE 4000, such as operations associated with display, telephone calls, data communications, camera operations, and recording operations. The processing component 4002 may include one or more processors 4020 to execute instructions to complete all or part of the steps of the above methods. In addition, the processing component 4002 may include at least one module to facilitate interactions between the processing component 4002 and other components. For example, the processing component 4002 may include a multimedia module to facilitate interactions between the multimedia component 4008 and the processing component 4002.

The memory 4004 is configured to store various types of data to support operations at the UE 4000. Examples of such data include instructions for any application or method operating on the UE 4000, contact data, phonebook data, messages, pictures, videos, etc. The memory 4004 may be implemented by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic storage, a flash memory, a magnetic disk or an optical disk.

The power supply component 4006 provides powers to various components of the UE 4000. The power supply component 4006 may include a power management system, at least one power supply, and other components associated with generating, managing, and distributing powers for the UE 4000.

The multimedia component 4008 includes a screen that provides an output interface between the UE 4000 and the user. In some embodiments, the screen may include a liquid crystal display (LCD) and a touch panel (TP). If the screen includes a touch panel, the screen may be implemented as a touch screen to receive an input signal from a user. The touch panel includes at least one touch sensor to sense touches, slides, and gestures on the touch panel. The touch sensor may not only sense a boundary of a touch or sliding action, but also detect a duration and pressure associated with the touch or sliding operation. In some embodiments, the multimedia component 4008 includes a front-facing camera and/or a rear-facing camera. When the UE 4000 is in an operation mode, such as a shooting mode or a video mode, the front camera and/or the rear camera may receive external multimedia data. Each of the front-facing camera and the rear-facing camera may be a fixed optical lens system or may have variable focal length and optical zoom capabilities.

The audio component 4010 is configured to output and/or input audio signals. For example, the audio component 4010 includes a microphone (MIC), which is configured to receive external audio signals when the UE 4000 is in an operating mode, such as a call mode, a recording mode, and a voice recognition mode. The received audio signal may be further stored in the memory 4004 or transmitted via the communication component 4016. In some embodiments, the audio component 4010 also includes a speaker for outputting audio signals.

The I/O interface 4012 provides an interface between the processing component 4002 and a peripheral interface module, which may be a keyboard, a click wheel, a button, etc. The button may include, but is not limited to: a home button, volume buttons, a start button, and a lock button.

The sensor component 4014 includes at least one sensor for providing status assessment of various aspects for the UE 4000. For example, the sensor component 4014 may detect an open/closed state of the UE 4000, a relative positioning of components, such as a display and a keypad of UE 4000. The sensor component 4014 may also detect position changes of the UE 4000 or a component of the UE 4000, a presence or absence of user contacts with the UE 4000, an orientation or an acceleration/deceleration of the UE 4000 and temperature changes of the UE 4000. The sensor component 4014 may include a proximity sensor configured to detect a presence of a nearby object without any physical contact. The sensor component 4014 may also include a light sensor, such as a CMOS or CCD image sensor, for use in imaging applications. In some embodiments, the sensor component 4014 may also include an acceleration sensor, a gyroscope sensor, a magnetic sensor, a pressure sensor, or a temperature sensor.

The communication component 4016 is configured to facilitate wired or wireless communication between the UE 4000 and other devices. The UE 4000 may access a wireless network based on a communication standard, such as WiFi, 2G, 3G, 4G or 5G, or their combination. In an exemplary embodiment, the communication component 4016 receives a broadcast signal or broadcast-related information from an external broadcast management system via a broadcast channel. In an exemplary embodiment, the communication component 4016 also includes a near field communication (NFC) module to facilitate short-range communications. For example, the NFC module may be implemented based on radio frequency identification (RFID) technology, infrared data association (IrDA) technology, ultra wideband (UWB) technology, Bluetooth (BT) technology, and other technologies.

In an exemplary embodiment, the UE 4000 may be implemented by at least one application-specific integrated circuit (ASIC), digital signal processor (DSP), digital signal processing device (DSPD), programmable logic device (PLD), field programmable gate array (FPGA), controller, microcontroller, microprocessor or other electronic components to perform the above-mentioned methods.

FIG. 41 is a block diagram illustrating a network device 4100 for authorization revocation provided in an embodiment of the disclosure. For example, the network device 4100 may be provided as a network side device. Referring to FIG. 41, the network device 4100 includes a processing component 4122, which further includes at least one processor, and a memory resource represented by a memory 4132 for storing instructions that can be executed by the processing component 4122, such as an application program. The application program stored in memory 4132 can include one or more modules each corresponding to a set of instructions. Alternatively, the processing component 4122 is configured to execute the instructions to perform any of the methods applied to the network device as described in the foregoing methods.

The network device 4100 may also include a power component 4126 configured to perform power management of the network device 4100, a wired or wireless network interface 4150 configured to connect the network device 4100 to a network, and an input/output (I/O) interface 4158. The network device 4100 can operate an operating system based on the operating system stored in the memory 4132, such as Windows Server™, Mac OS X™, Unix™, Linux™, FreeBSD™, or the like.

In the above embodiments provided in the disclosure, the methods in the embodiments of the disclosure are described from the perspectives of the network device and the UE, respectively. In order to realize each of the functions in the methods provided in the above embodiments of the disclosure, the network device and the UE may include a hardware structure, a software module, so that each of the above functions is implemented in the form of the hardware structure, the software module, or the hardware structure plus the software module. A certain one of the above functions may be performed in the form of the hardware structure, the software module, or the hardware structure plus the software module.

In the above embodiments provided in the disclosure, the methods in the embodiments of the disclosure are described from the perspectives of the network device and the UE, respectively. In order to realize each of the functions in the methods provided in the above embodiments of the disclosure, the network device and the UE may include a hardware structure, a software module, so that each of the above functions is implemented in the form of the hardware structure, the software module, or the hardware structure plus the software module. A certain one of the above functions may be performed in the form of the hardware structure, the software module, or the hardware structure plus the software module.

A communication apparatus is provided in an embodiment of the disclosure. The communication apparatus may include a transceiver module and a processing module. The transceiver module may include a sending module and/or a receiving module, the sending module is used for realizing a sending function, and the receiving module is used for realizing a receiving function, and the transceiver module may realize the sending function and/or the receiving function.

The communication apparatus may be the network device, or an apparatus in the network device, or an apparatus to be used together with the network device.

Another communication apparatus is provided in an embodiment of the disclosure. The communication apparatus may be a network device, a chip, a system on chip or a processor that supports the network device to implement the method, or a chip, a system on chip or a processor that supports the terminal to implement the method. The apparatus may be configured to implement the method described in the method embodiments, and may refer to descriptions in the method embodiments.

The communication apparatus may include one or more processors. The processor may include a general purpose processor or a dedicated processor. For example, the processor may be a baseband processor or a central processor. The baseband processor may be configured to process a communication protocol and communication data, and the central processor may be configured to control a communication apparatus (e.g., a network device, a baseband chip, a terminal, a terminal chip, a DU or CU, etc.), to execute a computer program, and process data of the computer program.

Optionally, the communication apparatus may further include one or more memories on which a computer program is stored. The computer program is executed by a processor, so that the communication apparatus is caused to perform the method as described in the above method embodiments. Optionally, the memory may further store data. The communication apparatus and the memory may be independently set or integrated together.

Optionally, the communication apparatus may further include a transceiver and an antenna. The transceiver may be referred to as a transceiving unit, a transceiver or a transceiving circuit, which may be configured to achieve a transceiving function. The transceiver may include a receiver and a transmitter. The receiver may be referred to as a receiver or a receiving circuit, etc., for implementing a receiving function; the transmitter may be referred to as a transmitter or a transmitting circuit, etc. for implementing a transmitting function.

Optionally, the communication apparatus may further include one or more interface circuits. The interface circuit is configured to receive code instructions and transmit the code instructions to the processor. When the code instructions are running on the processor, the communication apparatus is caused to perform the method according to the above method embodiments.

If the communication apparatus is a CAPIF core function/authorization function, the processor is configured to perform the method as illustrated in any one of FIG. 1 to FIG. 12.

If the communication apparatus is an API invoker, the processor is configured to perform the method as illustrated in any one of FIG. 13 to FIG. 16 or FIG. 21 to FIG. 24.

If the communication apparatus is an API exposure function, the processor is configured to perform the method as illustrated in any one of FIG. 17 to FIG. 20 or FIG. 25 to FIG. 33.

In an implementation, the processor may include a transceiver configured to implement receiving and transmitting functions. For example, the transceiver may be a transceiving circuit, or an interface, or an interface circuit. The transceiving circuit, the interface or the interface circuit configured to implement receiving and transmitting functions may be separate or integrated together. The transceiving circuit, the interface or the interface circuit may be configured to read and write codes/data, or the transceiving circuit, the interface or the interface circuit may be configured to transmit or deliver a signal.

In an implementation, the processor may be stored with a computer program. When the computer program is running on the processor, the communication apparatus is caused to perform the method as described in the above method embodiments. The computer program may be solidified in the processor, in which case the processor may be implemented by hardware.

In an implementation, the communication apparatus may include a circuit that may implement the transmitting or receiving or communicating function in the above method embodiments. The processor and the transceiver described in the disclosure may be implemented on integrated circuits (ICs), analog ICs, radio frequency integrated circuits (RFICs), mixed signal ICs, application specific integrated circuits (ASICs), printed circuit boards (PCBs), electronic devices, etc. The processor and the transceiver may further be fabricated by using various IC process technologies, such as complementary metal oxide semiconductor (CMOS), nMetal-oxide-semiconductor (NMOS), positive channel metal oxide semiconductor (PMOS), bipolar junction transistor(BJT), bipolar CMOS(BiCMOS), silicon germanium(SiGe) and gallium arsenide(GaAs).

The communication apparatus described in the above embodiments may be a network device, but the scope of the communication apparatus described in the disclosure is not limited thereto, and a structure of the communication apparatus may not be restricted. The communication apparatus may be a stand-alone device or may be a part of a larger device. For example, the communication apparatus may be:.
(1) a stand-alone integrated circuit (IC), or a chip, or a system on chip or a subsystem;
(2) a set of one or more ICs, optionally, which may also include a storage component for storing data and a computer program;
(3) an ASIC, such as a Modem;
(4) a module that may be embedded within other devices;
(5) a receiver, a terminal, a smart terminal, a cellular phone, a wireless device, a handset, a mobile unit, a vehicle device, a network device, a cloud device, an artificial intelligence device, etc.;
(6) others, and so forth.

In the case that the communication apparatus may be a chip or a system on chip, the chip includes a processor and an interface, in which there may be one or more processors, and there may be a plurality of interfaces.

Optionally, the chip further includes a memory, configured to save necessary computer program and data.

Those skilled in the related art may understand that, various illustrative logical blocks and steps listed in embodiments of the disclosure, may be implemented by electronic hardware, computer software or a combination of the electronic hardware and the computer software. Whether the function is implemented by the hardware or the software depends on specific applications and design requirements for an overall system. Those skilled in the art may implement the functions by using various methods for each specific application, but such an implementation should not be understood as going beyond the protection scope of embodiments of the disclosure.

A readable storage medium on which instructions are stored is further provided in the disclosure. When the instructions are executed by a computer, functions in the any one method embodiment are implemented.

A computer program product is further provided in the disclosure. The computer program product implements functions of the above any one method embodiment when executed by a processor.

In the above embodiments, the functions may be wholly or partially implemented by software, hardware, firmware, or any combination of them. When implemented by software, the functions may be implemented in whole or in part in the form of a computer program product. The computer program product includes one or more computer programs. Procedures or functions according to embodiments of the present disclosure are wholly or partially generated when the computer program is loaded and executed on a computer. The computer may be a general purpose computer, a special purpose computer, a computer network, or other programmable device. The computer program may be stored in a computer-readable storage medium or transmitted from one computer-readable storage medium to another. For example, the computer program may be transmitted from one website, computer, server, or data center to another website, computer, server, or data center via wire (such as a coaxial cable, a fiber optic, a digital subscriber line (DSL)) or wireless (such as infrared, wireless, microwave). The computer readable storage medium may be any available medium that may be accessed by a computer, or a data storage device such as a server that integrates one or more of the available media, and a data center. The available medium media be a magnetic medium (such as a floppy disk, a hard disk and a magnetic tape), an optical medium (such as a digital video disk (DVD)), or a semiconductor medium (such as a solid state disk (SSD)).

Those skilled in the art may understand that various numbers such as first and second involved in the present disclosure are distinguished merely for convenience of description, and are not intended to limit the scope of embodiments of the present disclosure, but also to indicate an order of precedence.

The term “at least one” in the present disclosure may also be described as one or more, and the more may be two, three, four, or more, which is not limited in the present disclosure. In the embodiment of the present disclosure, for a technical feature, the technical feature in the technical features are distinguished by terms “first”, “second”, “third”, “A”, “B”, “C” and “D”, etc., and the technical features described by the terms “first”, “second”, “third”, “A”, “B”, “C” and “D”, etc. are not in a sequential order or in an order of size.

Other implementations of the embodiments of the disclosure will be readily apparent to those skilled in the art from consideration of the specification and practice of the disclosure disclosed herein. This application is intended to cover any modification, use or adaptation of the embodiments of the disclosure, these modifications, uses or adaptations follow the general principles of the embodiments of the disclosure and include those in the technical field not disclosed by the embodiments of the disclosure Common knowledge or common technical means. The specification and examples are to be considered exemplary only, with a true scope of the embodiments of the disclosure being indicated by the following claims.

It should be understood that the disclosure is not limited to the precise structures described above and shown in the drawings, and various modifications and changes can be made without departing from the scope thereof. The scope of the disclosure is limited only by the appended claims.

1. A method for authorization revocation, performed by a common application programming interface framework (CAPIF) core function/authorization function, comprising:
receiving a first authorization revocation request sent by an application programming interface (API) invoker;
verifying the first authorization revocation request; and
in response to verification of the first authorization revocation request being passed, revoking a token corresponding to the first authorization revocation request.

2. The method according to claim 1, wherein revoking the token corresponding to the first authorization revocation request comprises one of:
revoking the token corresponding to the first authorization revocation request from the CAPIF core function/authorization function; or
revoking the token corresponding to the first authorization revocation request from an API exposure function.

3. The method according to claim 1, wherein the first authorization revocation request comprises at least one of:
an API invoker identity;
a first token that needs to be revoked; or
a token type corresponding to the first token that needs to be revoked.

4. The method according to claim 3, further comprising:
performing mutual authentication with the API invoker; and
in response to a successful mutual authentication, establishing a secure connection with the API invoker, and determining the API invoker identity is verified.

5. The method according to claim 3, wherein revoking the token corresponding to the first authorization revocation request from the API exposure function comprises:
determining a second token that needs to be revoked based on the first token that needs to be revoked and the token type; and
sending a second authorization revocation request to the API exposure function, wherein the second authorization revocation request indicates the API exposure function to revoke the second token that needs to be revoked.

6. The method according to claim 4, wherein verifying the first authorization revocation request comprises:
verifying attribution information of the first token that needs to be revoked based on the verified API invoker identity;
verifying a validation of the first token that needs to be revoked; and
in response to verification of the attribution information and verification of the validation being passed, determining that verification of the first authorization revocation request is passed.

7. The method according to claim 6, wherein verifying the attribution information of the first token that needs to be revoked based on the verified API invoker identity, comprises at least one of:
in response to the verified API invoker identity being identical to an API invoker identity corresponding to the first token that needs to be revoked, determining that the verification of the attribution information of the first token that needs to be revoked is passed; or
in response to determining that the verified API invoker identity may be mapped to the API invoker identity, determining that the verification of the attribution information of the first token that needs to be revoked is passed.

8. The method according to claim 6, wherein verifying the validation of the first token that needs to be revoked comprises:
verifying the validation of the first token that needs to be revoked using a public key.

9. The method according to claim 5, wherein determining the second token that needs to be revoked based on the first token that needs to be revoked and the token type comprises at least one of:
in response to the first token that needs to be revoked being an access token, using the first token that needs to be revoked as the second token that needs to be revoked; or
in response to the first token that needs to be revoked being a refresh token, using an access token corresponding to the first token that needs to be revoked as the second token that needs to be revoked.

10. The method according to claim 1, further comprising:
in response to verification of the first authorization revocation request being not passed, terminating the revocation procedure.

11. The method according to claim 5, further comprising:
receiving a first authorization revocation response fed back by the API exposure function; and
sending a second authorization revocation response to the API invoker.

12. A method for authorization revocation, performed by an application programming interface (API) invoker, comprising:
sending a first authorization revocation request to a common application programming interface framework (CAPIF) core function/authorization function.

13. The method according to claim 12, wherein the first authorization revocation request comprises at least one of:
an API invoker identity;
a first token that needs to be revoked; or
a token type corresponding to the first token that needs to be revoked.

14. The method according to claim 13, wherein sending the first authorization revocation request to the CAPIF core function/authorization function comprises at least one of:
sending the first authorization revocation request to the CAPIF core function/authorization function actively;
in response to the CAPIF core function/authorization function or the API exposure function requesting the API invoker to revoke the first token that needs to be revoked, sending the first authorization revocation request to the CAPIF core function/authorization function; or
in response to a resource owner corresponding to the first token that needs to be revoked requesting the API invoker to revoke the first token that needs to be revoked, sending the first authorization revocation request to the CAPIF core function/authorization function.

15. The method according to claim 12, further comprising at least one of:
performing mutual authentication with the CAPIF core function/authorization function; and
in response to a successful mutual authentication, establishing a secure connection with the CAPIF core function/authorization function, and determining the API invoker identity is verified; or
receiving a second authorization revocation response sent by the CAPIF core function/authorization function.

16. (canceled)

17. A method for authorization revocation, performed by an application programming interface (API) exposure function, comprising:
receiving a second authorization revocation request sent by a common application programming interface framework (CAPIF) core function/authorization function, wherein the second authorization revocation request indicates the API exposure function to revoke a second token that needs to be revoked; and
setting the second token that needs to be revoked as invalid.

18. The method according to claim 17, further comprising:
sending a first authorization revocation response to the CAPIF core function/authorization function.

19-36. (canceled)

37. A common application programming interface framework (CAPIF) core function/authorization function, comprising a processor and a memory storing a computer program, wherein when the computer program is executed by the processor, the CAPIF core function/authorization function is caused to perform the method according to claim 1.

38. An application programming interface (API) invoker, comprising a processor and a memory storing a computer program, wherein when the computer program is executed by the processor, the API invoker is caused to perform the method according to claim 12.

39. An application programming interface (API) exposure function, comprising a processor and a memory storing a computer program, wherein when the computer program is executed by the processor, the API exposure function is caused to perform the method according to claim 17.

40-42. (canceled)
